(19) United States
(12) Patent Application Publication
(10) Pub. No.: US 2024/0195952 A1
(43) Pub. Date: Jun. 13, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Zhipin DENG, Beijing (CN); Kai Zhang, Los Angeles, CA (US); Li Zhang, Los Angeles, CA (US)

(21) Appl. No.: 18/586,263

(22) Filed: Feb. 23, 2024

Related U.S. Application Data
(63) Continuation of application No. PCT/CN2022/113986, filed on Aug. 22, 2022.

(30) Foreign Application Priority Data
Aug. 23, 2021 (WO) PCT/CN2021/114163

(51) Int. Cl. H04N 19/103; H04N 19/176

(52) U.S. Cl. CPC H04N 19/103; H04N 19/176

(57) ABSTRACT

Embodiments of the present disclosure provide a solution for video processing. A method for video processing is proposed. The method comprises: determining, during a conversion between a target block of a video and a bitstream of the target block, a combined inter and intra prediction (CIIP) mode associated with the target block; constructing a merge candidate list associated with the CIIP mode; performing an adaptive merge list reordering to the merge candidate list associated with the CIIP mode; and performing the conversion based on the reordered merge candidate list.

### CROSS-REFERENCE TO RELATED APPLICATIONS

This application is a continuation of International Application No. PCT/CN2022/113986, filed on Aug. 22, 2022, which claims the benefit of International Application No. PCT/CN2021/114163 filed on Aug. 23, 2021. The entire contents of these applications are hereby incorporated by reference in their entireties.

### FIELD

Embodiments of the present disclosure relates generally to video coding techniques, and more particularly, to image/video processing technologies.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, during a conversion between a target block of a video and a bitstream of the target block, a combined inter and intra prediction (CIIP) mode associated with the target block; constructing a merge candidate list associated with the CIIP mode; performing an adaptive merge list reordering to the merge candidate list associated with the CIIP mode; and performing the conversion based on the reordered merge candidate list. Compared with conventional technologies, coding performance and coding efficiency can be improved.

In a second aspect, another method for video processing is proposed. The method comprises: determining, during a conversion between a target block of a video and a bitstream of the target block, a target motion candidate based on a plurality of motion vectors using a predetermined operation; constructing a motion candidate list for the target block; adding the target motion candidate into the motion candidate list; and performing the conversion based on the motion candidate list. Compared with conventional technologies, coding performance and coding efficiency can be improved.

In a third aspect, another method for video processing is proposed. The method comprises: determining, during a conversion between a target block of a video and a bitstream of the target block, a merge candidate list for the target block which is coded with a merge mode with motion vector differences (MMVD) mode; determining a plurality of merge candidates that are allowed for the MMVD mode; and performing the conversion based on the plurality of merge candidates. Compared with conventional technologies, coding performance and coding efficiency can be improved.

In a fourth aspect, an apparatus for processing video data is proposed. The apparatus for processing video data comprises a processor and a non-transitory memory with instructions thereon, wherein the instructions upon execution by the processor, cause the processor to perform: determining, during a conversion between a target block of a video and a bitstream of the target block, a combined inter and intra prediction (CIIP) mode associated with the target block; constructing a merge candidate list associated with the CIIP mode; performing an adaptive merge list reordering to the merge candidate list associated with the CIIP mode; and performing the conversion based on the reordered merge candidate list. Compared with conventional technologies, coding performance and coding efficiency can be improved.

In a fifth aspect, an apparatus for processing video data is proposed. The apparatus for processing video data comprises a processor and a non-transitory memory with instructions thereon, wherein the instructions upon execution by the processor, cause the processor to perform: determining, during a conversion between a target block of a video and a bitstream of the target block, a target motion candidate based on a plurality of motion vectors using a predetermined operation; constructing a motion candidate list for the target block; adding the target motion candidate into the motion candidate list; and performing the conversion based on the motion candidate list. Compared with conventional technologies, coding performance and coding efficiency can be improved.

In a sixth aspect, an apparatus for processing video data is proposed. The apparatus for processing video data comprises a processor and a non-transitory memory with instructions thereon, wherein the instructions upon execution by the processor, cause the processor to perform: determining, during a conversion between a target block of a video and a bitstream of the target block, a merge candidate list for the target block which is coded with a merge mode with motion vector differences (MMVD) mode; determining a plurality of merge candidates that are allowed for the MMVD mode; and performing the conversion based on the plurality of merge candidates. Compared with conventional technologies, coding performance and coding efficiency can be improved.

In a seventh aspect, an apparatus for processing video data is proposed. The non-transitory computer-readable storage medium stores instructions that cause a processor to perform determining, during a conversion between a target block of a video and a bitstream of the target block, a combined inter and intra prediction (CIIP) mode associated with the target block; constructing a merge candidate list associated with the CIIP mode; performing an adaptive merge list reordering to the merge candidate list associated with the CIIP mode; and performing the conversion based on the reordered merge candidate list. Compared with conventional technologies, coding performance and coding efficiency can be improved.

In an eighth aspect, an apparatus for processing video data is proposed. The non-transitory computer-readable storage medium stores instructions that cause a processor to perform determining, during a conversion between a target block of a video and a bitstream of the target block, a target motion candidate based on a plurality of motion vectors using a predetermined operation; constructing a motion candidate list for the target block; adding the target motion candidate into the motion candidate list; and performing the conversion based on the motion candidate list. Compared with conventional technologies, coding performance and coding efficiency can be improved.

In a ninth aspect, an apparatus for processing video data is proposed. The non-transitory computer-readable storage medium stores instructions that cause a processor to perform determining, during a conversion between a target block of a video and a bitstream of the target block, a merge candidate list for the target block which is coded with a merge mode with motion vector differences (MMVD) mode; determining a plurality of merge candidates that are allowed for the MMVD mode; and performing the conversion based on the plurality of merge candidates. Compared with conventional technologies, coding performance and coding efficiency can be improved.

In a tenth aspect, a non-transitory computer-readable recording medium is proposed. The non-transitory computer-readable recording medium stores a bitstream of a video which is generated by a method performed by a video processing apparatus, wherein the method comprises: determining a combined inter and intra prediction (CIIP) mode associated with a target block; applying an adaptive merge list reordering to the CIIP mode; and generating a bitstream of the target block based on the CIIP mode.

In an eleventh aspect, another method for video processing is proposed. The method for storing bitstream of a video comprises: determining a combined inter and intra prediction (CIIP) mode associated with a target block; applying an adaptive merge list reordering to the CIIP mode; generating a bitstream of the target block based on the CIIP mode; and storing the bitstream in a non-transitory computer-readable recording medium.

In a twelfth aspect, another non-transitory computer-readable recording medium is proposed. The non-transitory computer-readable recording medium stores a bitstream of a video which is generated by a method performed by a video processing apparatus, wherein the method comprises: determining a target motion candidate based on a plurality of motion vectors using a predetermined operation; constructing a motion candidate list for a target block; adding the target motion candidate into the motion candidate list; and generating a bitstream of the target block based on the motion candidate list.

In a thirteenth aspect, another method for video processing is proposed. The method for storing bitstream of a video comprises determining a target motion candidate based on a plurality of motion vectors using a predetermined operation; constructing a motion candidate list for a target block; adding the target motion candidate into the motion candidate list; and generating a bitstream of the target block based on the motion candidate list; and storing the bitstream in a non-transitory computer-readable recording medium.

In a fourteenth aspect, another non-transitory computer-readable recording medium is proposed. The non-transitory computer-readable recording medium stores a bitstream of a video which is generated by a method performed by a video processing apparatus, wherein the method comprises: determining, during a conversion between a target block of a video and a bitstream of the target block, a merge candidate list for the target block which is coded with a merge mode with motion vector differences (MMVD) mode; determining a plurality of merge candidates that are allowed for the MMVD mode; and generating a bitstream of the target block based on the plurality of merge candidates.

In a fifteenth aspect, another method for video processing is proposed. The method for storing bitstream of a video, comprises: determining, during a conversion between a target block of a video and a bitstream of the target block, a merge candidate list for the target block which is coded with a merge mode with motion vector differences (MMVD) mode; determining a plurality of merge candidates that are allowed for the MMVD mode; generating a bitstream of the target block based on the plurality of merge candidates; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a schematic diagram of intra prediction modes;

FIG. 5 illustrates a schematic diagram of reference samples for wide-angular intra prediction;

FIG. 6 illustrates a schematic diagram of problem of discontinuity in case of directions beyond 45°;

FIG. 7A is a schematic diagram illustrating definition of samples used by PDPC applied to a diagonal top-right mode;

FIG. 7B is a schematic diagram illustrating definition of samples used by PDPC applied to a diagonal bottom-left mode;

FIG. 7C is a schematic diagram illustrating definition of samples used by PDPC applied to an adjacent diagonal top-right mode;

FIG. 7D is a schematic diagram illustrating definition of samples used by PDPC applied to an adjacent diagonal bottom-left mode;

FIG. 8 illustrates a schematic diagram of example of four reference lines neighboring to a prediction block;

FIG. 9A is a schematic diagram illustrating examples of sub-partitions for 4×8 and 8×4 CUs;

FIG. 9B is a schematic diagram illustrating examples of sub-partitions for CUs other than 4×8, 8×4 and 4×4;

FIG. 10 illustrates matrix weighted intra prediction process;

FIG. 11 illustrates positions of spatial merge candidate;

FIG. 12 illustrates candidate pairs considered for redundancy check of spatial merge candidates;

FIG. 13 illustrates an illustration of motion vector scaling for temporal merge candidate;

FIG. 14 illustrates candidate positions for temporal merge candidate, C0 and C1;

FIG. 15 illustrates a schematic diagram of MMVD search point;

FIG. 16 illustrates extended CU region used in BDOF;

FIG. 17 illustrates an illustration for symmetrical MVD mode;

FIG. 18 illustrates decoding side motion vector refinement;

FIG. 19 illustrates top and left neighboring blocks used in CIIP weight derivation;

FIG. 20 illustrates CIIP_PDPC flowchart of the extended CIIP mode using PDPC;

FIG. 21 illustrates examples of the GPM splits grouped by identical angles;

FIG. 22 illustrates uni-prediction MV selection for geometric partitioning mode;

FIG. 23 illustrates exemplified generation of a bending weight w0 using geometric partitioning mode;

FIG. 24 illustrates proposed intra block decoding process;

FIG. 25 illustrates HoG computation from a template of width 3 pixels;

FIG. 26 illustrates prediction fusion by weighted averaging of two HoG modes and planar;

FIG. 27 illustrates a flow chart of a method according to embodiments of the present disclosure;

FIG. 28 illustrates a flow chart of a method according to embodiments of the present disclosure;

FIG. 29 illustrates a flow chart of a method according to embodiments of the present disclosure; and

FIG. 30 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

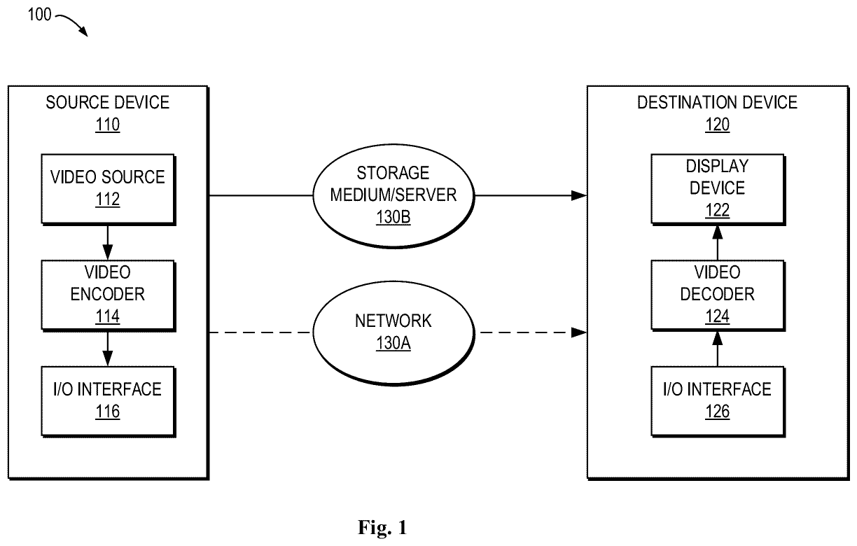

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

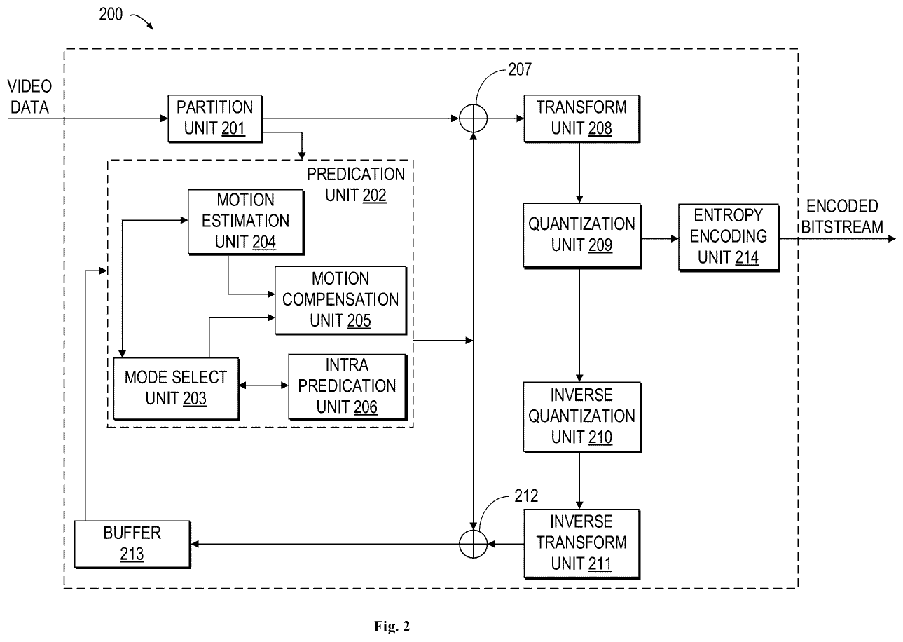

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

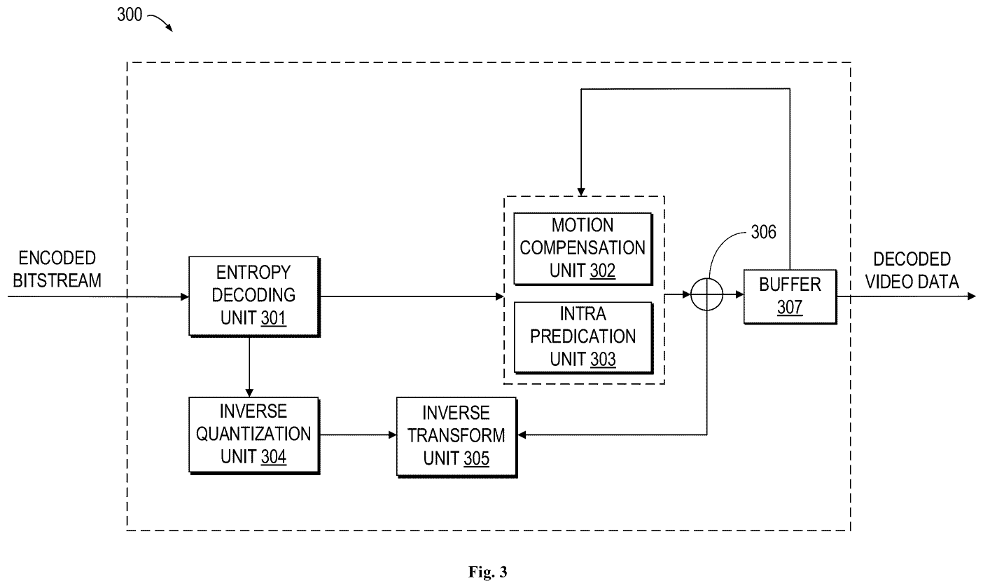

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1 SUMMARY

Embodiments of this disclosure are related to video coding technologies. Specifically, it is about extending the combined inter intra prediction technique to have advanced features such as motion enhancements, prediction enhancements and so on. It may be applied to the existing video coding standard like HEVC, VVC, and etc. It may be also applicable to future video coding standards or video codec.

### 2 BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC (ITU-T and ISO/IEC, “High efficiency video coding”, Rec. ITU-T H.265|ISO/IEC 23008-2 (in force edition)) standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1 Existing Coding Tools

### 2.1.1 Intra Prediction

2.1.1.1 Intra Mode Coding with 67 Intra Prediction Modes

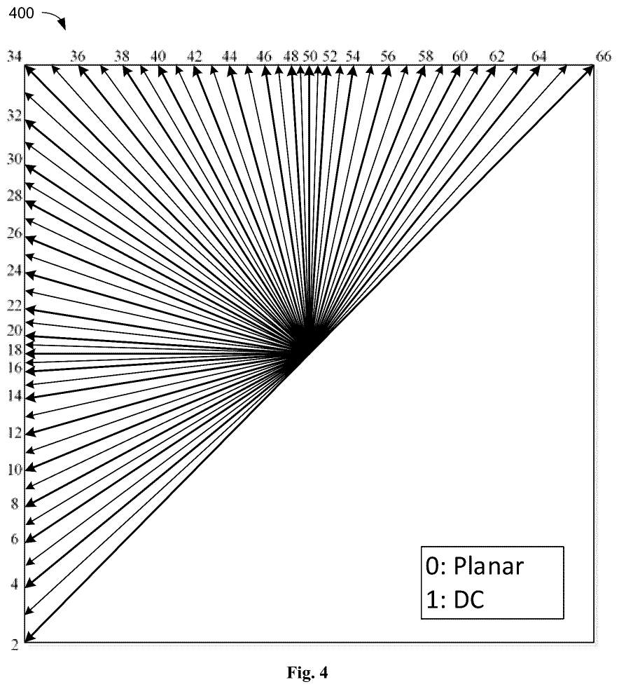

To capture the arbitrary edge directions presented in natural video, the number of directional intra modes in VVC is extended from 33, as used in HEVC, to 65. The new directional modes not in HEVC are depicted as red dotted arrows in FIG. 4, and the planar and DC modes remain the same. FIG. 4 is a schematic diagram 400 illustrating 67 intra prediction modes. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.1.1.2 Intra Mode Coding

To keep the complexity of the most probable mode (MPM) list generation low, an intra mode coding method with 6 MPMs is used by considering two available neighboring intra modes. The following three aspects are considered to construct the MPM list:
Default intra modes
Neighbouring intra modes
Derived intra modes

A unified 6-MPM list is used for intra blocks irrespective of whether MRL and ISP coding tools are applied or not. The MPM list is constructed based on intra modes of the left and above neighboring block. Suppose the mode of the left is denoted as Left and the mode of the above block is denoted as Above, the unified MPM list is constructed as follows:
When a neighboring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, DC, Max−1, Max+1, Max−2}
If Left and Above are both angular and they are different:
   Set a mode Max as the larger mode in Left and Above
   if the difference of mode Left and Above is in the range of 2 to 62, inclusive
      MPM list→{Planar, Left, Above, DC, Max−1, Max+1}
   Otherwise
      MPM list→{Planar, Left, Above, DC, Max−2, Max+2}
If Left and Above are both angular and they are the same:
   MPM list→{Planar, Left, Left−1, Left+1, DC, Left−2}

Besides, the first bin of the mpm index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

### 2.1.1.3 Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

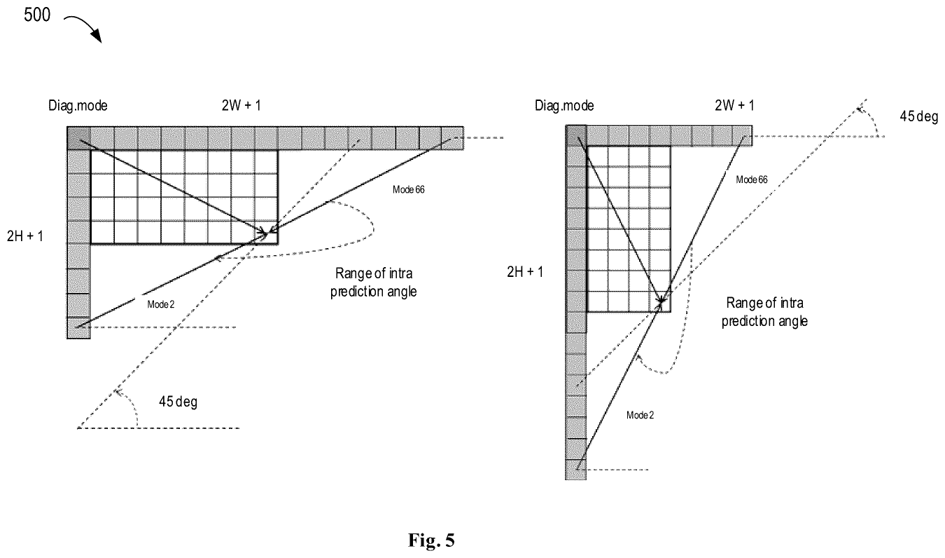

To support these prediction directions, the top reference with length 2W+1, and the left reference with length 2H+1, are defined as shown in FIG. 5. FIG. 5 is a schematic diagram 500 illustrating reference samples for wide-angular intra prediction.

The number of replaced modes in wide-angular direction mode depends on the aspect ratio of a block. The replaced intra prediction modes are illustrated in Table 2-1

TABLE 2-1
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == ½ | Modes 61, 62, 63, 64, 65, 66 |
| W/H == ¼ | Mode 57, 58, 59, 60, 61, 62, 63, 64, 65, 66 |
| W/H == ⅛ | Modes 55, 56 |
| W/H == 1/16 | Modes 53, 54, 55, 56 |

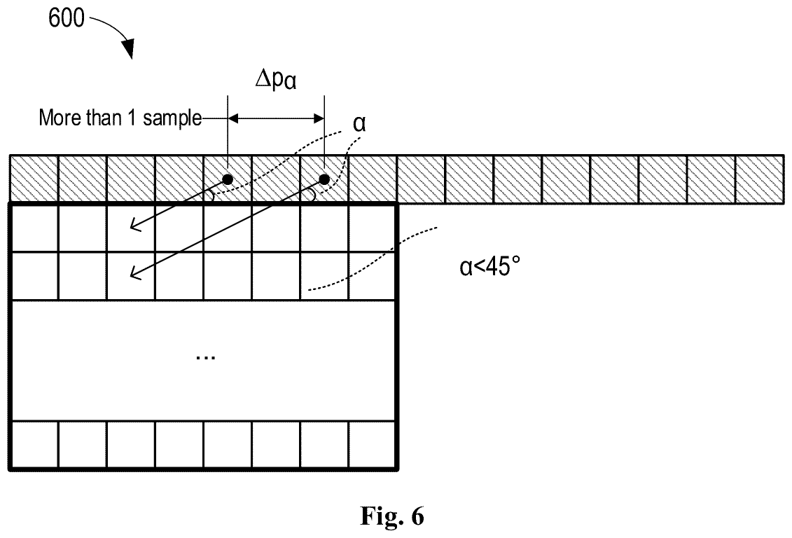

FIG. 6 is a schematic diagram 600 illustrating problem of discontinuity in case of directions beyond 45°. As shown in FIG. 6, two vertically-adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore chroma DM derivation table for 4:2:2: chroma format is updated by replacing some values of the entries of the mapping table to convert prediction angle more precisely for chroma blocks.

### 2.1.1.4 Mode Dependent Intra Smoothing (MDIS)

Four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, simplified 6-bit 4-tap Gaussian interpolation filter is used for only directional intra modes. Non-directional intra prediction process is unmodified. The selection of the 4-tap filters is performed according to the MDIS condition for directional intra prediction modes that provide non-fractional displacements, i.e. to all the directional modes excluding the following: 2, HOR_IDX, DIA_IDX, VER_IDX, 66.

Depending on the intra prediction mode, the following reference samples processing is performed:
The directional intra-prediction mode is classified into one of the following groups:
   vertical or horizontal modes (HOR_IDX, VER_IDX),
   diagonal modes that represent angles which are multiple of 45 degree (2, DIA_IDX, VDIA_IDX),
   remaining directional modes;
If the directional intra-prediction mode is classified as belonging to group A, then then no filters are applied to reference samples to generate predicted samples;
Otherwise, if a mode falls into group B, then a [1, 2, 1] reference sample filter may be applied (depending on the MDIS condition) to reference samples to further copy these filtered values into an intra predictor according to the selected direction, but no interpolation filters are applied;
Otherwise, if a mode is classified as belonging to group C, then only an intra reference sample interpolation filter is applied to reference samples to generate a predicted sample that falls into a fractional or integer position between reference samples according to a selected direction (no reference sample filtering is performed).

### 2.1.1.5 Position Dependent Intra Prediction Combination

In VVC, the results of intra prediction of DC, planar and several angular modes are further modified by a position dependent intra prediction combination (PDPC) method. PDPC is an intra prediction method which invokes a combination of the un-filtered boundary reference samples and HEVC style intra prediction with filtered boundary reference samples. PDPC is applied to the following intra modes without signalling: planar, DC, horizontal, vertical, bottom-left angular mode and its eight adjacent angular modes, and top-right angular mode and its eight adjacent angular modes.

The prediction sample pred(x′y′) is predicted using an intra prediction mode (DC, planar, angular) and a linear combination of reference samples according to the Equation 3-8 as follows: pred(x′y′)=(wL×R_{-1,y′}+wT×R_{x′,-1}−wTL×R_{-1,-1}+(64−wL−wT+wTL)×pred(x′,y′)+32)>>6 (2-1) where R_{x,-1}, R_{-1,y} represent the reference samples located at the top and left boundaries of current sample (x,y), respectively, and R_{-1,-1} represents the reference sample located at the top-left corner of the current block.

If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical and clipping operation is avoided. For angular modes, pdpc scale factor is adjusted such that range check is not needed and condition on angle to enable pdpc is removed (scale>=0 is used). In addition, PDPC weight is based on 32 in all angular mode cases. The PDPC weights are dependent on prediction modes and are shown in Table 2-2. PDPC is applied to the block with both width and height greater than or equal to 4.

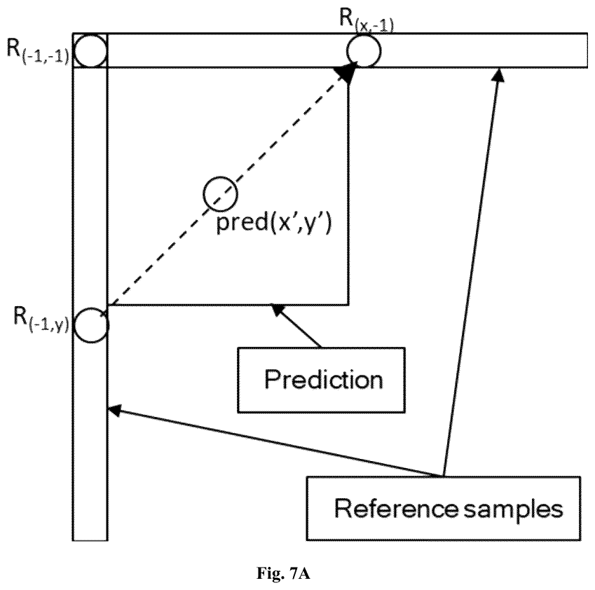

FIGS. 7A-7D illustrate the definition of reference samples (R_{x,-1}, R_{-1,y} and R_{-1,-1}) for PDPC applied over various prediction modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other annular mode, the reference samples R_{x,-1} and R_{-1,y} could be located in fractional sample position. In this case, the sample value of the nearest integer sample location is used.

TABLE 2-2
Example of PDPC weights according to prediction modes

| Prediction modes | wT | wL | wTL |
|---|---|---|---|
| Diagonal top-right | 16 >> ((y′ << 1) >> | 16 >> ((x′ << 1) >> | 0 |
| | shift) | shift) | |
| Diagonal bottom-left | 16 >> ((y′ << 1) >> | 16 >> ((x′ << 1) >> | 0 |
| | shift) | shift) | |
| Adjacent diagonal | 32 >> ((y′ << 1) >> | 0 | 0 |
| top-right | shift) | | |
| Adjacent diagonal | 0 | 32 >> ((x′ << 1) >> | 0 |
| bottom-left | | shift) | |

### 2.1.1.6 Multiple Reference Line (MRL) Intra Prediction

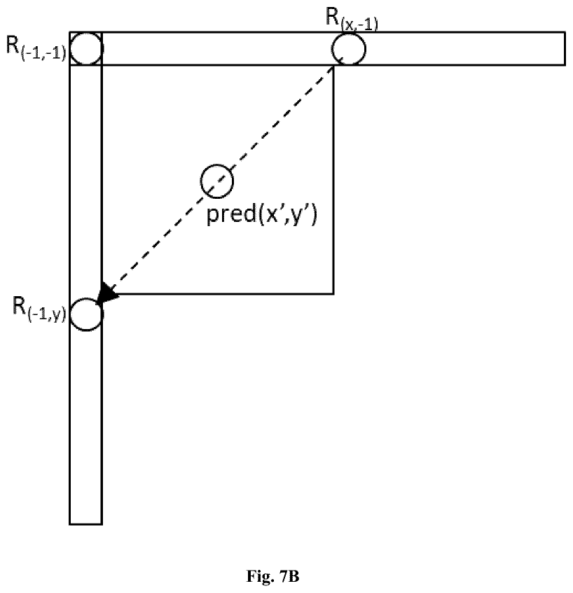

Multiple reference line (MRL) intra prediction uses more reference lines for intra prediction. In FIG. 8 is a schematic diagram 800 illustrating an example of four reference lines neighbouring to a prediction block. In FIG. 8, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signalled and used to generate intra predictor. For reference line idx, which is greater than 0, only include additional reference line modes in MPM list and only signal mpm index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices is aligned with that of reference line index 0. MRL requires the storage of 3 neighboring luma reference lines with a CTU to generate predictions. The Cross-Component Linear Model (CCLM) tool also requires 3 neighboring luma reference lines for its downsampling filters. The definition of MLR to use the same 3 lines is aligned as CCLM to reduce the storage requirements for decoders.

### 2.1.1.7 Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\frac{M}{2} \times 64 chroma$$

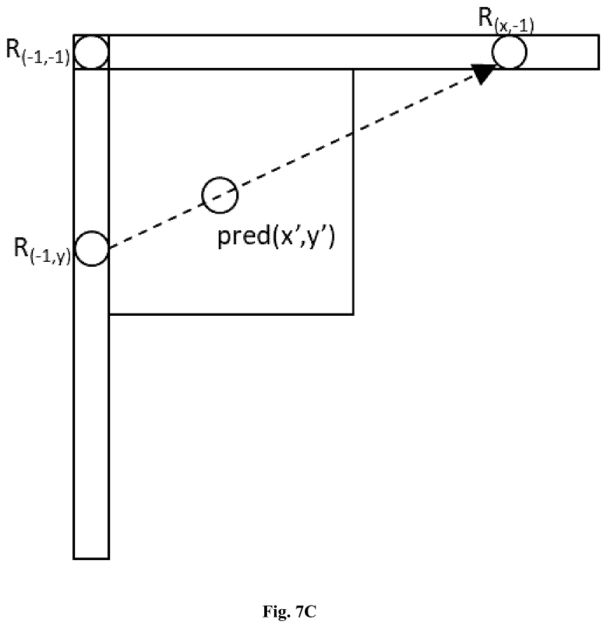

TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIGS. 9a-9b show examples of the two possibilities. FIG. 9A is a schematic diagram 902 illustrating examples of sub-partitions for 4×8 and 8×4 CUs. FIG. 9B is a schematic diagram 904 illustrating examples of sub-partitions for CUs other than 4×8, 8×4 and 4×4. All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 2-3
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 2-3. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
MPM usage: the MPM flag will be inferred to be one in a block coded by ISP mode, and the MPM list is modified to exclude the DC mode and to prioritize horizontal intra modes for the ISP horizontal split and vertical intra modes for the vertical one.
Transform size restriction: all ISP transforms with a length larger than 16 points uses the DCT-II.
PDPC: when a CU uses the ISP coding mode, the PDPC filters will not be applied to the resulting sub-partitions.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let t_{H} and t_{V} be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w=2 or w>32, t_{H}=DCT-II
   If h=2 or h>32, t_{V}=DCT-II
   Otherwise, the transform is selected as in Table 2-4.

TABLE 2-4
Transform selection depends on intra mode

| Intra mode | t_{H} | t_{V} |
|---|---|---|
| Planar | DST-VII | DST-VII |
| Ang. 31, 32, 34, 36, 37 | | |
| DC | DCT-II | DCT-II |
| Ang. 33, 35 | | |
| Ang. 2, 4, 6 . . . 28, 30 | DST-VII | DCT-II |
| Ang. 39, 41, 43 . . . 63, 65 | | |
| Ang. 3, 5, 7 . . . 27, 29 | DCT-II | DST-VII |
| Ang. 38, 40, 42 . . . 64, 66 | | |

In ISP mode, all 67 intra modes are allowed. PDPC is also applied if corresponding width and height is at least 4 samples long. In addition, the condition for intra interpolation filter selection doesn't exist anymore, and Cubic (DCT-IF) filter is always applied for fractional position interpolation in ISP mode.

### 2.1.1.8 Matrix Weighted Intra Prediction (MIP)

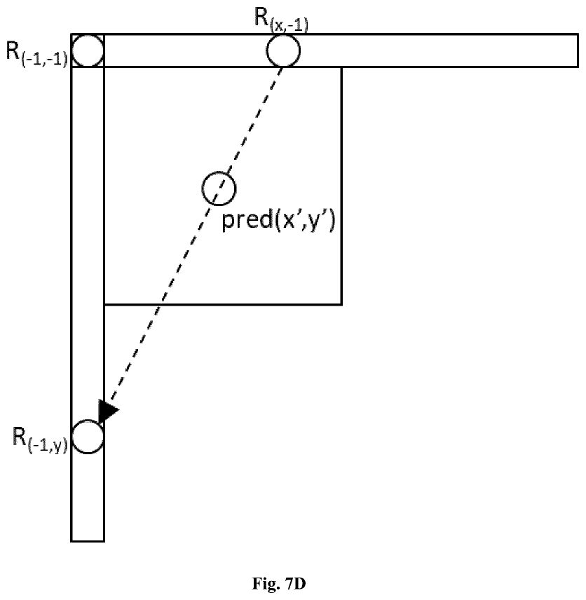

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 10. FIG. 10 is a schematic diagram 1000 illustrating matrix weighted intra prediction process.

### Averaging Neighboring Samples

Among the boundary samples, four samples or eight samples are selected by averaging based on block size and shape. Specifically, the input boundaries bdry^{top} and bdry^{left} are reduced to smaller boundaries bdry_{red}^{top} and bdry_{red}^{left} by averaging neighboring boundary samples according to predefined rule depends on block size. Then, the two reduced boundaries bdry_{red}^{top} and bdry_{red}^{left} are concatenated to a reduced boundary vector bdry_{red} which is thus of size four for blocks of shape 4×4 and of size eight for blocks of all other shapes. If mode refers to the MIP-mode, this concatenation is defined as follows:

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6\end{matrix} . \qquad ( 2 - 2 )$$

### Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the downsampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 2 - 3 )$$

$${H}_{red} = \{ \begin{matrix}4 & for max ( W , H ) \leq 8 \\ min ( H , 8 ) & for max ( W , H ) > 8\end{matrix} \qquad ( 2 - 4 )$$

The reduced prediction signal pred_{red} is computed by calculating a matrix vector product and adding an offset:

pred_{red}=A·bdry_{red}+b.

Here, A is a matrix that has W_{red}·H_{red} rows and 4 columns if W=H=4 and 8 columns in all other cases. b is a vector of size W_{red}, H_{red}. The matrix A and the offset vector b are taken from one of the sets S₀, S₁, S₂. One defines an index idx=idx(W,H) as follows:

$$idx ( W , H ) = \{ \begin{matrix}0 & for W = H = 4 \\ 1 & for max ( W , H ) = 8 \\ 2 & for max ( W , H ) > 8\end{matrix} . \qquad ( 2 - 5 )$$

Here, each coefficient of the matrix A is represented with 8 bit precision. The set S₀ consists of 16 matrices A₀ⁱ, i∈{0, . . . , 15} each of which has 16 rows and 4 columns and 16 offset vectors b₀ⁱ, i∈{0, . . . , 16} each of size 16. Matrices and offset vectors of that set are used for blocks of size 4×4. The set S₁ consists of 8 matrices A₁ⁱ, i∈{0, . . . , 7}, each of which has 16 rows and 8 columns and 8 offset vectors b₁ⁱ, i∈{0, . . . , 7} each of size 16. The set S₂ consists of 6 matrices A₂ⁱ, i∈{0, . . . , 5}, each of which has 64 rows and 8 columns and of 6 offset vectors by, i∈{0, . . . , 5} of size 64.

### Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

Signaling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signaled. For an MIP mode, a transposed flag (isTransposed), which determines whether the mode is transposed, and MIP mode Id (modeId), which determines which matrix is to be used for the given MIP mode is derived as follows

isTransposed=predModeIntra&1

modeId=predModeIntra>>1 (2-6)

MIP coding mode is harmonized with other coding tools by considering following aspects:
LFNST is enabled for MIP on large blocks. Here, the LFNST transforms of planar mode are used
The reference sample derivation for MIP is performed exactly as for the conventional intra prediction modes
For the upsampling step used in the MIP-prediction, original reference samples are used instead of downsampled ones
Clipping is performed before upsampling and not after upsampling
MIP is allowed up to 64×64 regardless of the maximum transform size
The number of MIP modes is 32 for sizeId=0, 16 for sizeId=1 and 12 for sizeId=2

### 2.1.2 Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following text provides the details on those inter prediction methods specified in VVC.

### 2.1.2.1 Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### Spatial Candidates Derivation

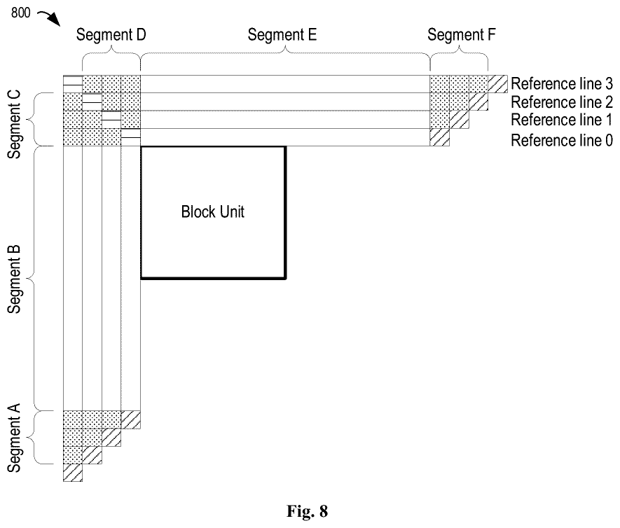

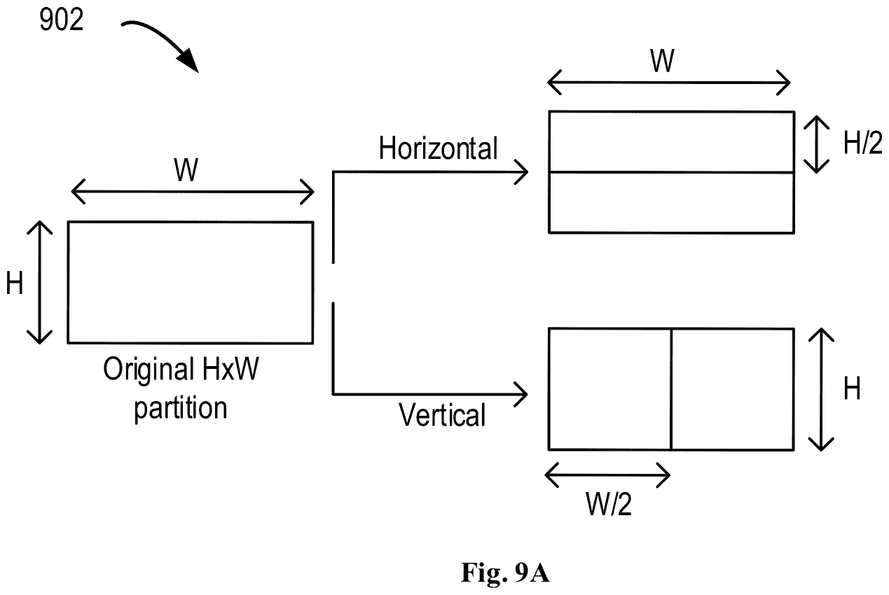

The derivation of spatial merge candidates in VVC is same to that in HEVC except the positions of first two merge candidates are swapped. FIG. 11 is a schematic diagram 1100 illustrating positions of a spatial merge candidate. A maximum of four merge candidates are selected among candidates located in the positions depicted in FIG. 11. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 12 is a schematic diagram 1200 illustrating candidate pairs considered for redundancy check of spatial merge candidates. Instead only the pairs linked with an arrow in FIG. 12 are considered and a candidate is only added to the list if the corresponding candidate used for redundancy check has not the same motion information.

### Temporal Candidates Derivation

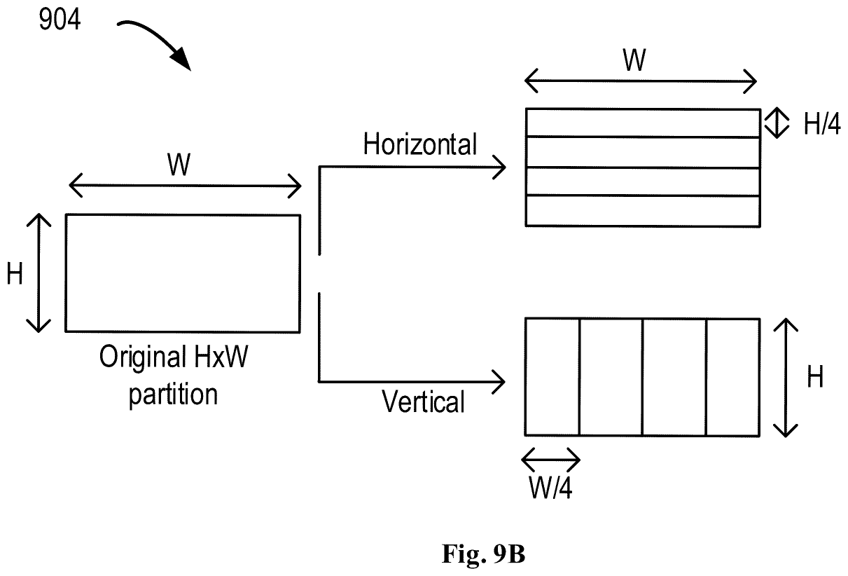

In this step, only one candidate is added to the list. Particularly, in the derivation of this temporal merge candidate, a scaled motion vector is derived based on co-located CU belonging to the collocated referenncee picture. The reference picture list to be used for derivation of the co-located CU is explicitly signalled in the slice header. The scaled motion vector for temporal merge candidate is obtained as illustrated by the dotted line in the diagram 1300 of FIG. 13, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

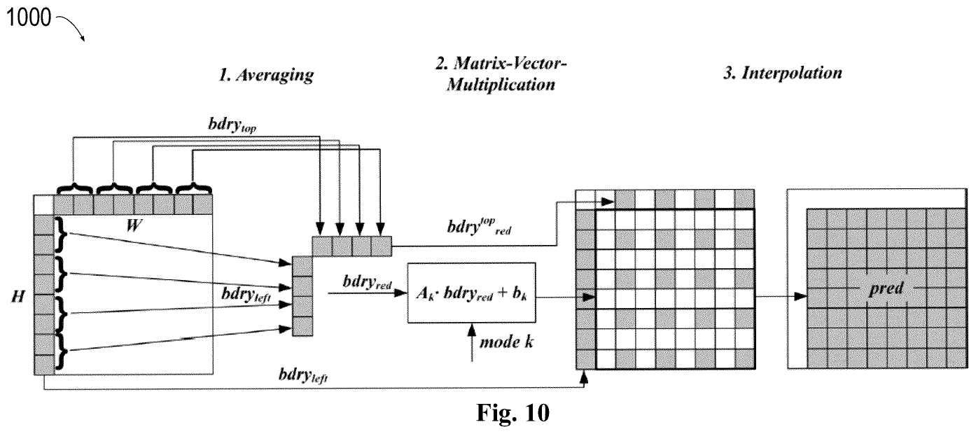

FIG. 14 is a schematic diagram 1400 illustrating candidate positions for temporal merge candidate, C₀ and C₁. The position for the temporal candidate is selected between candidates C₀ and C₁, as depicted in FIG. 14. If CU at position C₀ is not available, is intra coded, or is outside of the current row of CTUs, position C₁ is used. Otherwise, position C₀ is used in the derivation of the temporal merge candidate.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward,

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. Number of HMPV candidates is used for merge list generation is set as (N<=4)? M: (8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid. When the merge list is not full after pair-wise average merge candidates are added, the zero MVPs are inserted in the end until the maximum merge candidate number is encountered.

### Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

2.1.2.2 Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

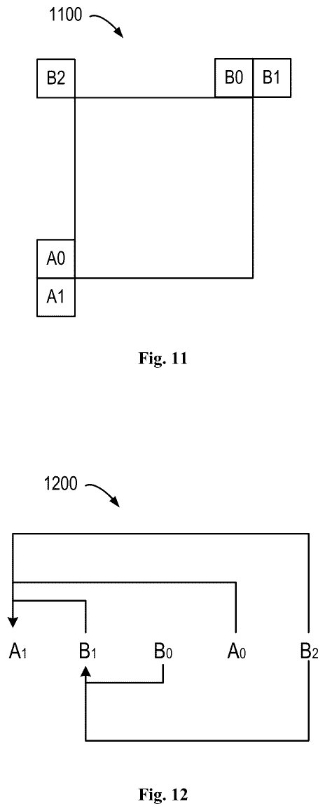

Distance index specifies motion magnitude information and indicate the pre-defined offset from the starting point. FIG. 15 is a schematic diagram 1500 illustrating a merge mode with motion vector differences (MMVD) search point. As shown in FIG. 15, an offset is added to either horizontal component or vertical component of starting MV. The relation of distance index and pre-defined offset is specified in Table 2-5

TABLE 2-5
The relation of distance index and pre-defined offset

| Distance IDX | 0 | 1 | 2 | 3 | 4 | 5 | 6 | 7 |
|---|---|---|---|---|---|---|---|---|
| Offset (in unit of | 1/4 | 1/2 | 1 | 2 | 4 | 8 | 16 | 32 |
| luma sample) | | | | | | | | |

Direction index represents the direction of the MVD relative to the starting point. The direction index can represent of the four directions as shown in Table 2-6. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2-6 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 2-6 specifies the sign of MV offset added to the list0 MV component of starting MV and the sign for the list1 MV has opposite value.

TABLE 2-6
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

2.1.2.3 Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

P_{bi-pred}=((8−w)*P₀+w*P₁+4)>>3 (2-7)

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. For further details readers are referred to the VTM software and document JVET-L0646. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g. equal weight.

### 2.1.2.4 Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order
The distances (i.e. POC difference) from two reference pictures to the current picture are same
Both reference pictures are short-term reference pictures.
The CU is not coded using affine mode or the ATMVP merge mode
CU has more than 64 luma samples
Both CU height and CU width are larger than or equal to 8 luma samples
BCW weight index indicates equal weight
WP is not enabled for the current CU
CIIP mode is not used for the current CU

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0,1, of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) >> shift 1 ) - ( {I}^{( k )} ( i - 1 , j ) >> shift 1 ) ) \qquad ( 2 - 8 )$$

$$\frac{\partial {I}^{( k )}}{\partial y} ( i , j ) = ( ( {I}^{( k )} ( i , j + 1 ) >> shift 1 ) - ( {I}^{( k )} ( i , j - 1 ) >> shift 1 ) )$$

where I^{(k)}(i,j) are the sample value at coordinate (i,j) of the prediction signal in list k, k=0,1, and shift1 is calculated based on the luma bit depth, bitDepth, as shift1=max(6, bitDepth−6).

Then, the auto- and cross-correlation of the gradients, S₁, S₂, S₃, S₅ and S₆, are calculated as

$${S}_{1} = {\sum }_{( i , j ) ∈ Ω} Abs ( {ψ}_{x} ( i , j ) ) , \\ {S}_{3} = {\sum }_{( i , j ) ∈ Ω} θ ( i , j ) \cdot Sign ( {ψ}_{x} ( i , j ) ) \qquad ( 2 - 9 )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , \\ {S}_{6} = {\sum }_{( i , j ) ∈ Ω} θ ( i , j ) \cdot Sign ( {ψ}_{y} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) >> {n}_{a} \qquad ( 2 - 10 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) >> {n}_{a}$$

$$θ ( i , j ) = ( {I}^{( 1 )} ( i , j ) >> {n}_{b} ) - ( {I}^{( 0 )} ( i , j ) >> {n}_{b} )$$

where Ω is a 6×6 window around the 4×4 subblock, and the values of nₐ and n_{b} are set equal to min(1, bitDepth−11) and min(4, bitDepth−8), respectively.

The motion refinement (vₓ, v_{y}) is then derived using the cross- and auto-correlation terms using the following:

vₓ=S₁>0?clip3(−th′_{BIO′}th′_{BIO′}−((S₃·2ⁿ^{_{b}}⁻ⁿ^{ₐ})>>└log₂S₁┘)):0

v_{y}=S₅>0?clip3(−th′_{BIO′}th′_{BIO′}−((S₆·2ⁿ^{_{b}}⁻ⁿ^{ₐ}−(vₓS_{2,m})<<n_{S}_{₂}+vₓS_{2,s})/2)>>└log₂S₅┘)):0 (2-11)

where

$${S}_{2 , m} = {S}_{2} >> {n}_{{S}_{2}} , {S}_{2 , s} = {S}_{2} \& ( {2}^{{n}_{{S}_{2}}} - 1 ) , t {h}_{BIO}^{′} = {2}^{max ( 5 , BD - 7 )} .$$

└·┘ is the floor function, and n_{S}_{₂}=12.

Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 ) \qquad ( 2 - 12 )$$

Finally, the BDOF samples of the CU are calculated by adjusting the bi-prediction samples as follows:

pred_{BDOF}(x,y)=(I⁽⁰⁾(x,y)+I⁽¹⁾(x,y)+b(x,y)+o_{offset})>>shift (2-13)

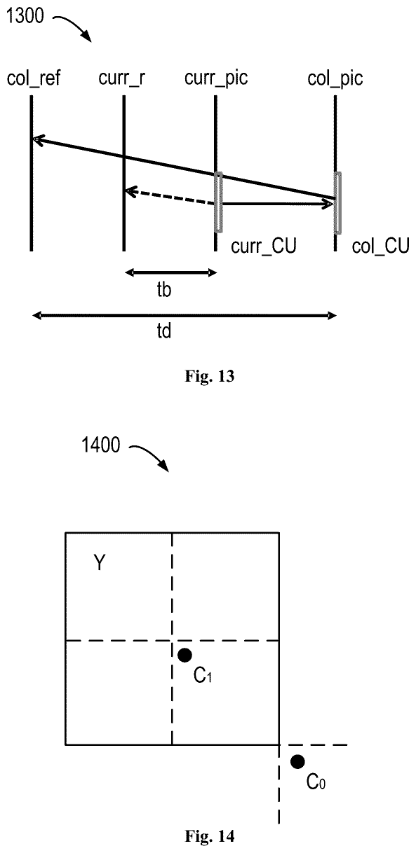

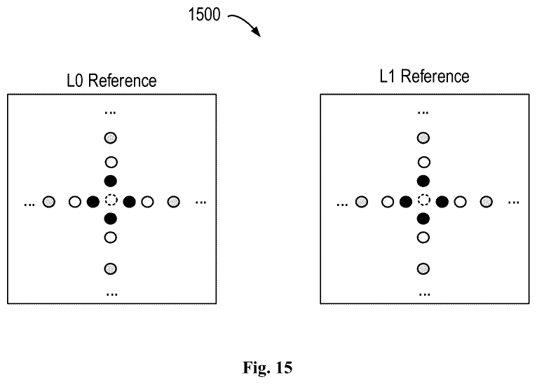

These values are selected such that the multipliers in the BDOF process do not exceed 15-bit, and the maximum bit-width of the intermediate parameters in the BDOF process is kept within 32-bit. In order to derive the gradient values, some prediction samples I^{(k)}(i,j) in list k (k=0,1) outside of the current CU boundaries need to be generated. FIG. 16 illustrates a schematic diagram of extended CU region used in BDOF. As depicted in the diagram 1600 of FIG. 16, the BDOF in VVC uses one extended row/column around the CU's boundaries. In order to control the computational complexity of generating the out-of-boundary prediction samples, prediction samples in the extended area (denoted as 1610 in FIG. 16) are generated by taking the reference samples at the nearby integer positions (using floor( ) operation on the coordinates) directly without interpolation, and the normal 8-tap motion compensation interpolation filter is used to generate prediction samples within the CU (denoted as 1620 in FIG. 16). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_1×_flag is 1 for either of the two reference pictures, then BDOF is also disabled. When a CU is coded with symmetric MVD mode or CIIP mode, BDOF is also disabled.

### 2.1.2.5 Symmetric MVD Coding

In VVC, besides the normal unidirectional prediction and bi-directional prediction mode MVD signalling, symmetric MVD mode for bi-predictional MVD signalling is applied. In the symmetric MVD mode, motion information including reference picture indices of both list-0 and list-1 and MVD of list-1 are not signaled but derived.

The decoding process of the symmetric MVD mode is as follows:
1) At slice level, variables BiDirPredFlag, RefIdxSymL0 and RefIdxSymL1 are derived as follows:
   If mvd_l1_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2) At CU level, a symmetrical mode flag indicating whether symmetrical mode is used or not is explicitly signaled if the CU is bi-prediction coded and BiDirPredFlag is equal to 1.

FIG. 14 is an illustration for symmetrical MVD mode. When the symmetrical mode flag is true, only mvp_l0_flag, mvp_l1_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( {mvx}_{0} , {mvy}_{0} ) & = ( {mvpx}_{0} + {mvdx}_{0} , {mvpy}_{0} + {mvdy}_{0} ) \\ ( {mvx}_{1} , {mvy}_{1} ) & = ( {mvpx}_{1} - {mvdx}_{0} , {mvpy}_{1} - {mvdy}_{0} )\end{matrix} \qquad ( 2 - 14 )$$

In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

### 2.1.2.6 Decoder Side Motion Vector Refinement (DMVR)

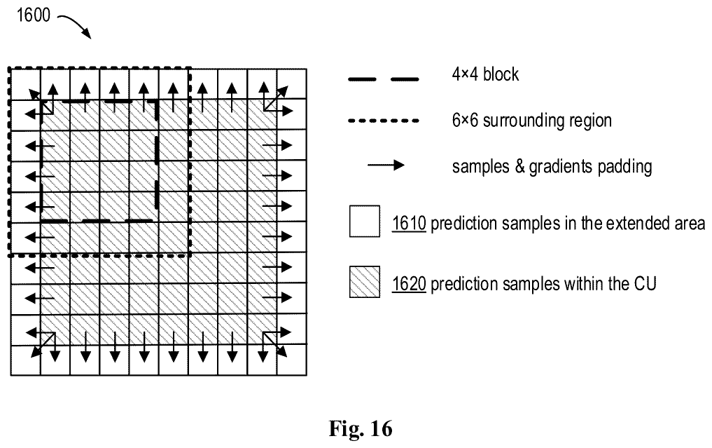

In order to increase the accuracy of the MVs of the merge mode, a bilateral-matching based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 18 is a schematic diagram illustrating the decoding side motion vector refinement. As illustrated in FIG. 18, the SAD between the blocks 1810 and 1812 based on each MV candidate around the initial MV is calculated, where the block 1810 is in a reference picture 1801 in the list L0 and the block 1812 is in a reference picture 1803 in the List L1 for the current picture 1802. The MV candidate with the lowest SAD becomes the refined MV and used to generate the bi-predicted signal.

In VVC, the DMVR can be applied for the CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

MV0′=MV0+MV_offset (2-15)

MV1′=MV1−MV_offset (2-16)

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

E(x,y)=A(x−xₘᵢₙ)²+B(y−yₘᵢₙ)²+C (2-17)

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

xₘᵢₙ=(E(−1,0)−E(1,0))/(2(E(−1,0)+E(1,0)−2E(0,0))) (2-18)

yₘᵢₙ=(E(0,−1)−E(0,1))/(2((E(0,−1)+E(0,1)−2E(0,0))) (2-19)

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.1.2.7 Combined Inter and Intra Prediction (CIIP)

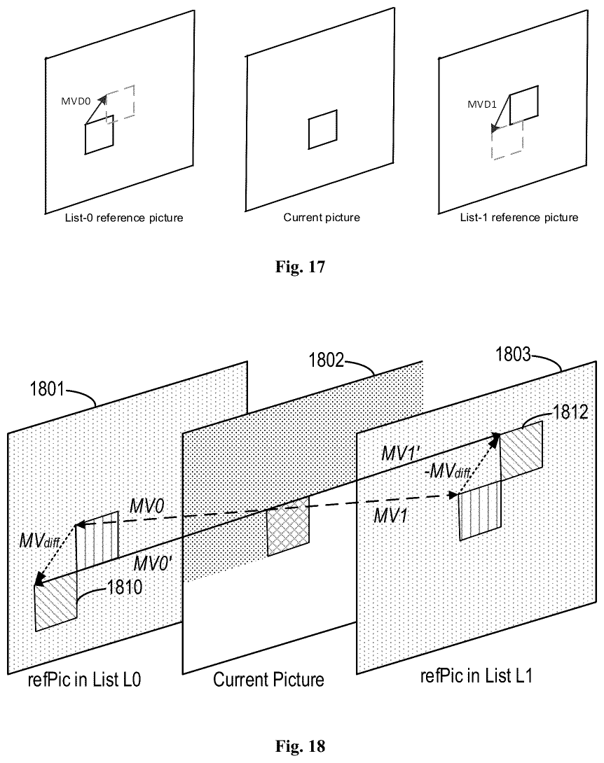

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in a schematic diagram 1900 in FIG. 19) as follows:

If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

P_{CIIP}=(4−wt)*Pᵢₙₜₑᵣ+wt*Pᵢₙₜᵣₐ+2)>>2 (2-20)

2.1.2.8 CIIP with PDPC Blending

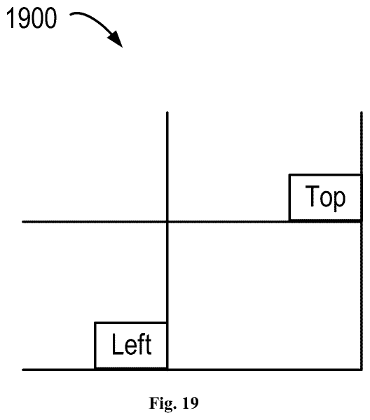

The CIIP mode is extended to blend a merge prediction with a PDPC predictor (CIIP_PDPC), the prediction of the regular merge mode is refined using the above (Rx, −1) and left (R−1, y) reconstructed samples. This refinement inherits the position dependent prediction combination (PDPC) scheme. The flowchart of the prediction of the CIIP_PDPC mode can be depicted as in FIG. 20, where WT and WL are the weighted values which depend on the sample position in the block as defined in PDPC.

The CIIP_PDPC mode is signaled together with CIIP mode. When CIIP flag is true, another flag, namely CIIP_PDPC flag, is further signaled to indicate whether to use CIIP_PDPC.

### 2.1.2.9 Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

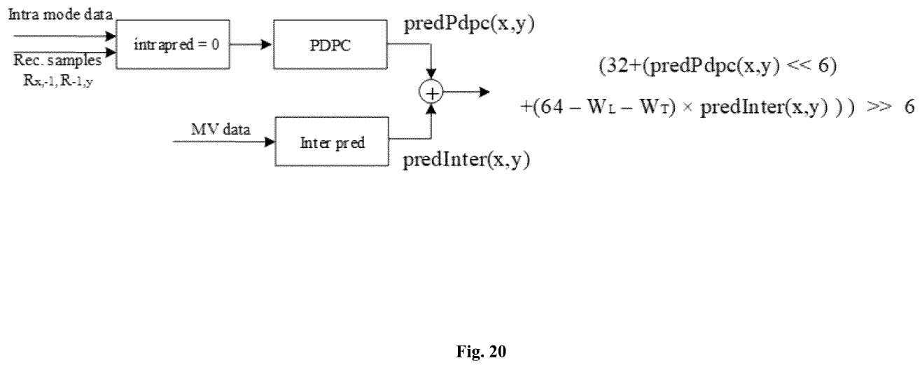

FIG. 21 shows a schematic diagram 2100 of examples of the GPM splits grouped by identical angles. When this mode is used, a CU is split into two parts by a geometrically located straight line (FIG. 21). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### Uni-Prediction Candidate List Construction

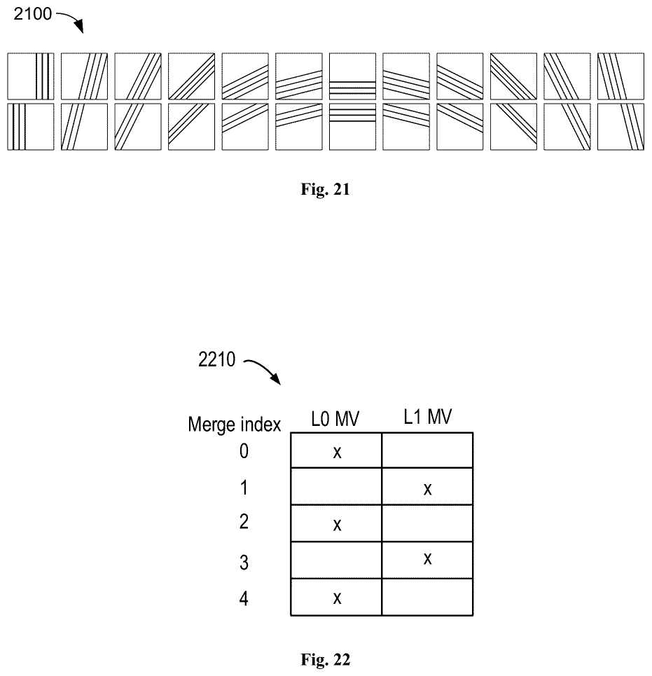

The uni-prediction candidate list is derived directly from the merge candidate list constructed according to the extended merge prediction process. FIG. 22 is a schematic diagram illustrating the uni-prediction MV selection for geometric partitioning mode. Denote n as the index of the uni-prediction motion in the geometric uni-prediction candidate list 2210. The LX motion vector of the n-th extended merge candidate, with X equal to the parity of n, is used as the n-th uni-prediction motion vector for geometric partitioning mode. These motion vectors are marked with “x” in FIG. 22. In case a corresponding LX motion vector of the n-th extended merge candidate does not exist, the L(1−X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x,y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 21 )$$

$${ρ}_{j} = {ρ}_{x , j} cos ( {φ}_{i} ) + {ρ}_{y , j} sin ( {φ}_{i} ) \qquad ( 2 - 22 )$$

$${ρ}_{x , j} = \{ \begin{matrix}0 & i \% 16 = 8 or ( i \% 16 \neq 0 and h \geq w ) \\ \pm ( j \times w ) >> 2 & otherwise\end{matrix} \qquad ( 2 - 23 )$$

$${ρ}_{y , j} = \{ \begin{matrix}\pm ( j \times h ) >> 2 & i \% 16 = 8 or ( i \% 16 \neq 0 and h \geq w ) \\ 0 & otherwise\end{matrix} \qquad ( 2 - 24 )$$

where i,j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 2 - 25 )$$

$${w}_{0} ( x , y ) = \frac{Clip 3 ( 0 , 8 , ( wIdxL ( x , y ) + 4 ) >> 3 )}{8} \qquad ( 2 - 26 )$$

$${w}_{1} ( x , y ) = 1 - {w}_{0} ( x , y ) \qquad ( 2 - 27 )$$

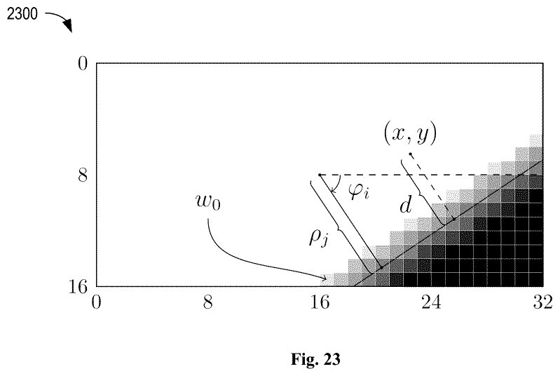

The partIdx depends on the angle index i. One example of weigh w₀ is illustrated in the diagram 2300 in FIG. 23.

### Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

sType=abs(motionIdx)<32?2:(motionIdx≤0?(1−partIdx):partIdx) (2-43)

where motionIdx is equal to d(4x+2, 4y+2), which is recalculated from equation (2-36). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### 2.1.2.10 Multi-Hypothesis Prediction (MHP)

In the multi-hypothesis prediction, up to two additional predictors are signalled on top of inter AMVP mode, regular merge mode, and MMVD mode. The resulting overall prediction signal is accumulated iteratively with each additional prediction signal.

pₙ₊₁=(1−αₙ₊₁)pₙ+αₙ₊₁hₙ₊₁

The weighting factor α is specified according to the following table:

| add_hyp_weight_idx | α |
|---|---|
| 0 | ¼ |
| 1 | −⅛ |

For inter AMVP mode, MHP is only applied if non-equal weight in BCW is selected in bi-prediction mode.

### 2.1.2.11 Adaptive Reordering of Merge Candidates (ARMC)

The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. For simplification, merge candidates in the last but not the first subgroup are not reordered.

The template matching cost of a merge candidate is measured by the sum of absolute differences (SAD) between samples of a template of the current block and their corresponding reference samples. The template comprises a set of reconstructed samples neighboring to the current block. Reference samples of the template are located by the motion information of the merge candidate.

### 2.1.3 Decoder Side Intra Mode Derivation (DIMD)

Three angular modes are selected from a Histogram of Gradient (HoG) computed from the neighboring pixels of current block. Once the three modes are selected, their predictors are computed normally and then their weighted average is used as the final predictor of the block. To determine the weights, corresponding amplitudes in the HoG are used for each of the three modes. The DIMD mode is used as an alternative prediction mode and is always checked in the FullRD mode.

Current version of DIMD has modified some aspects in the signaling, HoG computation and the prediction fusion. The purpose of this modification is to improve the coding performance as well as addressing the complexity concerns raised during the last meeting (i.e. throughput of 4×4 blocks). The following sections describe the modifications for each aspect.

### Signalling

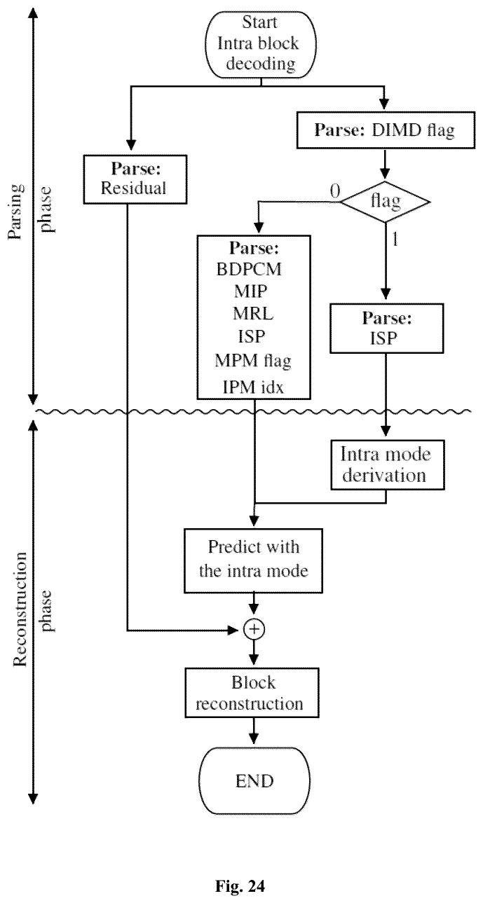

FIG. 24 shows the order of parsing flags/indices in VTM5, integrated with the proposed DIMD. As can be seen, the DIMD flag of the block is parsed first using a single CABAC context, which is initialized to the default value of 154.

If flag==0, then the parsing continues normally.

Else (if flag==1), only the ISP index is parsed and the following flags/indices are inferred to be zero: BDPCM flag, MIP flag, MRL index. In this case, the entire IPM parsing is also skipped.

During the parsing phase, when a regular non-DIMD block inquires the IPM of its DIMD neighbor, the mode PLANAR_IDX is used as the virtual IPM of the DIMD block.

### Texture Analysis

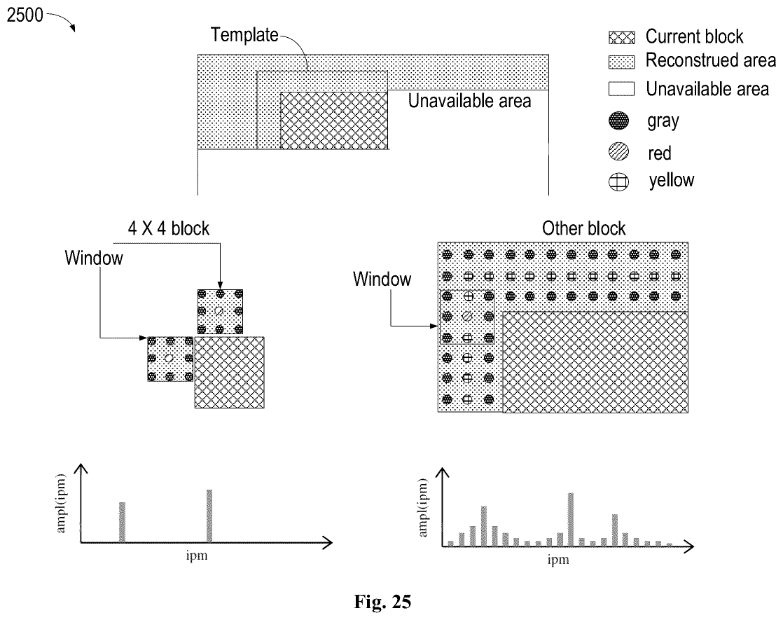

The texture analysis of DIMD includes a Histogram of Gradient (HoG) computation (FIG. 25). The HoG computation is carried out by applying horizontal and vertical Sobel filters on pixels in a template of width 3 around the block. Except, if above template pixels fall into a different CTU, then they will not be used in the texture analysis.

Once computed, the IPMs corresponding to two tallest histogram bars are selected for the block.

In previous versions, all pixels in the middle line of the template were involved in the HoG computation. However, the current version improves the throughput of this process by applying the Sobel filter more sparsely on 4×4 blocks. To this aim, only one pixel from left and one pixel from above are used. This is shown in FIG. 25. FIG. 25 is a schematic diagram 2500 illustrating HoG computation from a template of width 3 pixels.

In addition to reduction in the number of operations for gradient computation, this property also simplifies the selection of best 2 modes from the HoG, as the resulting HoG cannot have more than two non-zero amplitudes.

### Prediction Fusion

This method uses a fusion of three predictors for each block. However, it is proposed that the choice of prediction modes is different and makes use of the combined hypothesis intra-prediction method, where the Planar mode is considered to be used in combination with other modes when computing an intra-predicted candidate. In the current version, the two IPMs corresponding to two tallest HoG bars are combined with the Planar mode.

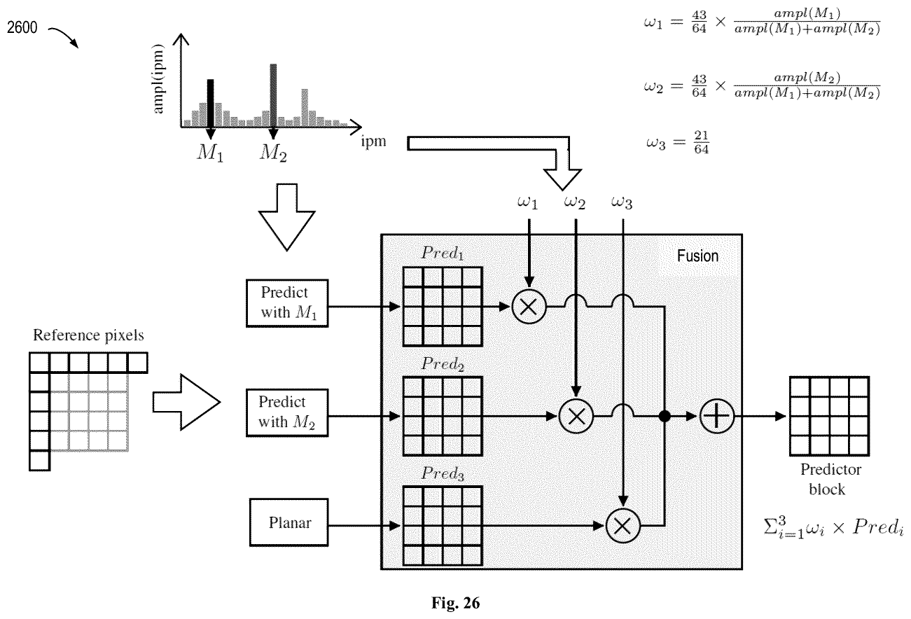

The prediction fusion is applied as a weighted average of the above three predictors. To this aim, the weight of planar is fixed to 21/64 (˜⅓). The remaining weight of 43/64 (˜⅔) is then shared between the two HoG IPMs, proportionally to the amplitude of their HoG bars. FIG. 26 visualises this process. FIG. 26 is a schematic diagram 2600 illustrating prediction fusion by weighted averaging of two HoG modes and planar.

### 2.1.4 Template-Based Intra Mode Derivation (TIMD)

A TIMD mode is derived from MPMs using the neighbouring template. The TIMD mode is used as an additional intra prediction method for a CU.

### TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) is included in the derivation of the TIMD mode.

### TIMD Signalling

A flag is signalled in sequence parameter set (SPS) to enable/disable the proposed method. When the flag is true, a CU level flag is signalled to indicate whether the proposed TIMD method is used. The TIMD flag is signalled right after the MIP flag. If the TIMD flag is equal to true, the remaining syntax elements related to luma intra prediction mode, including MRL, ISP, and normal parsing stage for luma intra prediction modes, are all skipped.

### Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list. This modification is only applied to the derivation of the TIMD mode.

### 3 OTHER EMBODIMENTS

### 3.1 on Prediction List Pruning, Concatenating MMVD and Template Matching

The detailed embodiments below should be considered as examples to explain general concepts. These embodiments should not be interpreted in a narrow way. Furthermore, these embodiments can be combined in any manner.

The term ‘GPM’ may represent a coding method that split one block into two or more partition/sub-regions wherein at least one partition/sub-region is non-rectangular, or non-square, or it couldn't be generated by any of existing partitioning structure (e.g., QT/BT/TT) which splits one block into multiple rectangular sub-regions. In one example, for the GPM coded blocks, one or more weighting masks are derived for a coding block based on how the sub-regions are split, and the final prediction signal of the coding block is generated by a weighted-sum of two or more auxiliary prediction signals associated with the sub-regions.

The term ‘GPM’ may indicate the geometric merge mode (GEO), and/or geometric partition mode (GPM), and/or wedge prediction mode, and/or triangular prediction mode (TPM), and/or a GPM block with motion vector difference (GMVD), and/or a GPM block with motion refinement, and/or any variant based on GPM. The term ‘block’ may represent a coding block (CB), a CU, a PU, a TU, a PB, a TB.

It should also be noticed that GPM/GMVD applied to other modes (e.g., AMVP mode) may also use the following methods wherein the merge candidate list may be replaced by an AMVP candidate list.

The phrase “normal/regular merge candidate” may represent the merge candidates generated by the extended merge prediction process (as illustrated in section 2.1.1). It may also represent any other advanced merge candidates except GPM merge candidates and subblock based merge candidates.

The term “TM” may refer to template matching which predict

The term “pruning/prune” in embodiments of the present disclosure may refer to a redundancy check of two candidates, such as during the motion candidate list (e.g., merge list, AMVP list, GPM list, TM list and etc.) construction process. For example, before inserting a new candidate to the motion candidate list, the new candidate is compared with at least one of the existing candidates in the motion candidate list, and only if certain conditions (e.g., motion/reference index is somehow different from the existing candidate, and etc.) are satisfied, the new candidate would be finally inserted to the motion candidate list.

The term “prediction list” in embodiments of the present disclosure may refer to a certain or whatever prediction list comprising more than one motion candidates for video coding procedure, such as GPM candidate list, MHP prediction list for additional hypothesis, MHP base hypothesis candidate list, TM prediction list, DMVR prediction list, BDMVR prediction list, affine AMVP list, affine merge list, regular merge list, regular AMVP list, sbTMVP prediction list, and etc.

In the following discussion, a “new candidate” may refer to a candidate that is considered to be inserted into the candidate list during the candidate list construction procedure. An “existing candidate” may refer to a candidate that is already in the candidate list during the candidate list construction procedure.
1. In one example, during the process of a prediction list generation/construction, whether to insert a new motion candidate to the list may be dependent on a comparison between itself and at least one existing candidate in the prediction list.
   a. For example, regarding the determination of whether to insert the new motion candidate to the prediction list, the new motion candidate may be compared with all existing candidates in the prediction list.
   b. For example, regarding the determination of whether to insert the new motion candidate to the prediction list, the new motion candidate may be first compared with at most Y (Y is a pre-defined value, such as X=1 or 2) existing candidates at certain pre-defined positions in the prediction list.
      a. For example, the certain pre-defined positions may be at most Y candidates from the end of the prediction list.
      b. For example, the certain pre-defined positions may be the first and third candidates from the end of the prediction list.
      c. For example, the certain pre-defined position may be the second candidate from the end of the prediction list.
      d. For example, the certain pre-defined position may be the first candidate from the end of the prediction list.
   c. For example, when comparing the new candidate with an existing candidate in the prediction list, identical check may be applied.
      a. For example, when comparing the new candidate with an existing candidate in the prediction list, motion vector identical check may be applied.
         i. For example, if the motion vector of the new candidate and the existing candidate in the prediction list are identical (both horizontal and vertical components of motion vectors are the same, both L0 motion and L1 motion are the same), the new candidate may not be inserted to the prediction list.
      b. For example, when comparing the new candidate with an existing candidate in the prediction list, reference index identical check may be applied.
         i. For example, if the reference index of the new candidate and the existing candidate in the prediction list are identical (both L0 motion and L1 motion are the same), the new candidate may not be inserted to the prediction list.
      c. For example, when comparing the new candidate with an existing candidate in the prediction list, BCW index check may be applied.
      d. For example, when comparing the new candidate with an existing candidate in the prediction list, LIC flag check may be applied.
      e. For example, when comparing the new candidate with an existing candidate in the prediction list, OBMC flag check may be applied.
      f. For example, when comparing the new candidate with an existing candidate in the prediction list, motion vector precision (e.g., 1/16-pel, ⅛-pel, ¼-pel, ½-pel, 1-pel, 4-pel precision, and etc) check may be applied.
      g. For example, when comparing the new candidate with an existing candidate in the prediction list, interpolation filter (e.g., half-pel interpolation filter, and etc) check may be applied.
      h. For example, when both the above conditions are satisfied, the new candidate may not be inserted to the prediction list.
      i. For example, a first piece of side information may or may NOT be considered to determine whether two candidates are identical or not.
         i. In one example, the first piece of side information may be the BCW index.
         ii. In one example, the first piece of side information may be the LIC flag.
   d. For example, when comparing the new candidate with an existing candidate in the prediction list, one or more thresholds may be used to determine how different they are.
      a. For example, a first threshold may be used to determine the allowed motion vector difference for the candidates.
         i. In one example, if the absolute MV difference of two candidates is smaller or no greater than the threshold, the two candidates are treated as identical.
      b. For example, a second threshold may be used to determine the reference index difference of the candidates.
      c. For example, a threshold may be signaled from the encoder to the decoder.
      d. For example, the threshold may be dependent on decoded information.
      e. In one example, the decoded information may comprise the motion vector precision of a motion candidate.
         i. In one example, the decoded information may comprise BCW information.
         ii. In one example, the decoded information may comprise LIC information.
         iii. In one example, the decoded information may comprise motion compensation interpolation filter information.
         iv. In one example, the decoded information may comprise OBMC information.
         v. For example, the decoded information may comprise the width and/or height of the coding unit.
         vi. For example, the decoded information may comprise types of prediction list generations.
         In one example, the difference check threshold for prediction list A generation may be different from that used for prediction list B generation, wherein A and B are two prediction list types.
         vii. For example, the difference check threshold for prediction list A generation may be same as the difference check threshold for prediction list B generation, wherein A and B are two prediction list types.
         Additionally, the whole difference check procedure (more than the threshold) for prediction list A generation may be same as the difference check threshold for prediction list B generation.
         For example, A or B may be GPM candidate list generation.
         For example, A or B may be MHP prediction list generation for additional hypothesis.
         For example, A or B may be MHP base hypothesis candidate list generation.
         For example, A or B may be TM candidate list generation.
         For example, A or B may be DMVR candidate list generation.
         For example, A or B may be BDMVR candidate list generation.
         For example, A or B may be Affine AMVP candidate list generation.
         For example, A or B may be Affine merge candidate list generation.
         For example, A or B may be regular merge candidate list generation.
         For example, A or B may be regular AMVP candidate list generation.
         For example, A or B may be SbTMVP candidate list generation.
2. In one example, how to perform pruning process during the determination of inserting a new candidate to a prediction list, may be dependent on the coded/decoded information.
   a. For example, whether to use pruning process may be dependent on the reference picture list information.
      a. For example, if the reference picture information (e.g., POC distance, reference index, and etc) in list0 and list1 are referring to a same reference picture, then pruning process may be not applied to the latter candidate.
         i. Additionally, the latter candidate may be not inserted to the prediction list.
      b. For example, the prediction list refers to uni-directional prediction list (e.g., GPM list, MHP prediction list for additional hypothesis generation).
      c. For example, the prediction list refers to bi-directional prediction list.
      d. For example, the prediction list may comprise both uni-directional and bi-directional candidates.
   b. For example, whether to use identical motion vector check (e.g., bullet 1.d) or threshold-based motion vector check (e.g., bullet 1.e), may be dependent on the reference picture list information.
      a. In one example, if all reference pictures in list 0 and list 1 are the same, the identical motion vector check may be applied.
      b. In one example, if all reference pictures in list 0 and list 1 are the same, the identical threshold-based motion vector check may be applied.
      c. In one example, if at least one of the reference pictures in list 0 and list 1 are different, the identical motion vector check may be applied.
      d. In one example, if at least one of the reference pictures in list 0 and list 1 are different, the identical threshold-based motion vector check may be applied.
3. In one example, one or more generated candidates may be appended at the end of a prediction list until the prediction list is full.
   a. For example, the prediction list is a GPM prediction list.
   b. For example, the prediction list is a MHP prediction list for additional hypothesis generation.
   c. For example, how many candidates to be appended to a prediction list may be dependent on the maximum allowed length of the prediction list.
      a. For example, the maximum allowed length of a prediction list may be pre-defined.
      b. For example, the maximum allowed length of a prediction list may be signalled in the bitstream.
   d. For example, if the number of candidates (e.g., after pruning) is less than the maximum allowed length of the prediction list, then additional candidates may be inserted to the prediction list, until the number of candidates reach the maximum length of the prediction list.
   e. For example, the additional candidates may be generated by averaging certain available candidates in the list.
      a. Additionally, the pruning process may be applied to averaged candidates.
      b. alternatively, the pruning process may not be applied to averaged candidates.
      c. The process of “averaging” on candidates may comprise an averaging process on MVs of the candidates.
   f. For example, the additional candidates may be zero motion candidates.
      a. For example, zero motion candidates may be appended at the end of the prediction list.
      b. Additionally, the pruning process may not be applied to zero motion candidates at the end of the list.
   g. Alternatively, one or more generated candidates may be appended at the end of a prediction list, and the prediction list after filling may be not full.
      a. For example, a fixed number of averaged candidates may be inserted to the prediction list.
      b. For example, a fixed number of zero motion candidates may be inserted to the prediction list.
4. In one example, in case that a template matching based motion refinement is applied to GPM (or, CIIP, MHP additional hypothetic, and etc) motion candidates, the above pruning process (bullet 1 to 4) may be applied to the accordingly template matching based prediction list generation.
5. In one example, in case that a template matching based motion refinement is applied to GPM (or, CIIP, MHP additional hypothetic, and etc) motion candidates, a candidate reordering process may be applied during the template matching based GPM list generation.
   a. For example, the candidate reordering process may be based on a criterion, wherein the cost value of each candidate may be evaluated from current picture neighboring samples information and/or reference picture reference samples information.
   b. For example, the candidate reordering process may be applied before the pruning process.
   c. For example, the candidate reordering process may be applied after the pruning process.
6. In one example, a decoder-side motion refinement approach, e.g template-matching-based (TM-based) motion refinement, and a motion-vector-difference-based (MMVD-based) method may be applied to a video unit. In the following discussion, TM-based method may be replaced by any other decoder-side motion refinement approach.
   a. For example, the TM-based method may refer that the motion predictor/candidate of the video unit is refinement (e.g., implicitly refined at the decoder side) by a TM-based method.
   b. For example, the MMVD-based method may refer that a motion vector difference is explicitly signalled and add up to a motion predictor/candidate of the video unit.
   c. For example, both TM-based method and MMVD-based method may be allowed for a GPM coded video unit.
   d. For example, both TM-based method and MMVD-based method may be allowed for a CIIP coded video unit.
   e. For example, both TM-based method and MMVD-based method may be allowed for a MHP coded video unit (e.g., base hypothesis, and/or additional hypothesis).
   f. For example, both TM-based method and MMVD-based method may be allowed for a regular merge coded video unit.
   g. For example, TM-based method related syntax elements may be signalled after the MMVD-based method related syntax elements.
      a. For example, whether and how to signal TM related syntax elements, may be dependent on MMVD information.
         i. For example, the MMVD information may refer to MMVD offset value.
         ii. For example, TM related syntax elements may be signalled for a coding unit, under the condition that zero MMVD offset is applied to the video unit.
         iii. For example, TM related syntax elements may be signalled for a partition/subpartition/subblock of a coding unit (e.g., GPM coded block), under the condition that zero MMVD offset is applied to the specific partition/subpartition/subblock of the coding unit.
         iv. For example, TM related syntax elements may be signalled for a coding unit, under the condition that all partitions/subpartitions/subblocks (e.g., GPM coded block) of a coding unit are coded with zero MMVD offset.
      b. In one example, TM related syntax elements may be signalled for a video unit, even though MMVD related syntax elements are signalled.
         i. In one example, the MVD signaled by the MMVD method may be added to the MV of the video unit first and then the resulted MV is further refined by a template-matching-based method.
      c. For example, if TM related syntax elements are not signalled, they may be inferred to certain values (indicating that TM-based method is not applied to the video unit).
   h. For example, TM-based method related syntax elements may be signalled before the MMVD-based method related syntax elements.
      a. For example, whether and how to signal MMVD related syntax elements, may be dependent on whether TM is applied to the video unit.
         i. For example, MMVD related syntax elements may be signalled for a coding unit, under the condition that TM based method is not used to the video unit.
         ii. For example, MMVD related syntax elements may be signalled for a partition/subpartition/subblock of a coding unit (e.g., GPM coded block), under the condition that TM is NOT applied to the specific partition/subpartition/subblock of the coding unit.
         iii. For example, MMVD related syntax elements may be signalled for a coding unit, under the condition that all partitions/subpartitions/subblocks (e.g., GPM coded block) of a coding unit are NOT coded with TM.
      b. In one example, MMVD related syntax elements may be signalled for a video unit, even though TM related syntax elements are signalled.
         i. In one example, the MV of a partition may be refined by a template-matching-based method first, then the MVD signaled by the MMVD method may be further added to the refined MV.
      c. For example, if MMVD related syntax elements are not signalled, they may be inferred to certain values (indicating that MMVD-based method is not applied to the video unit).
   i. For example, the above-mentioned TM-based method related syntax elements may refer to a TM flag for an entire video unit, and/or separate TM flags for separate partitions/subpartitions/subblocks of a video unit, and/or TM based merge/AMVP candidate index, and etc.
   j. For example, the above-mentioned MMVD-based method related syntax elements may refer to a MMVD flag for an entire video unit, and/or separate MMVD flags for separate partitions/subpartitions/subblocks of a video unit, and/or MMVD based merge candidate index, and/or MMVD offset direction, and/or MMVD offset distance/step, and etc.
   k. In one example, the TM-based method may be applied before the MMVD process. The motion vector may be first refined by the TM-based method, then added by a signaled MVD.
   l. In one example, the TM-based method may be applied after the MMVD process. The motion vector may be first added by a signaled MVD, then refined by the TM-based method.
7. In one example, in case that an explicit motion refinement and/or an implicit motion refinement are allowed to be used to a video unit (where the video unit contains more than one subblock/subpartition/partition), the motion candidate (e.g., merge index) of a first subblock/subpartition/partition and the motion candidate of a second subblock/subpartition/partition of the video unit may NOT be allowed to be same (e.g., different motion candidates should be used for at least two partitions of a video unit).
   a. Alternatively, under such case, the motion candidate of a first subblock/subpartition/partition and the motion candidate of a second subblock/subpartition/partition of the video unit may be allowed to be same (e.g., same motion candidates are allowed for all partitions of a video unit).
   b. For example, the motion candidate of an implicit motion refinement for a first subblock/subpartition/partition and the motion candidate of an implicit motion refinement for a second subblock/subpartition/partition of the video unit may NOT be allowed to be same.
      a. Alternatively, the motion candidate of an implicit motion refinement for a first subblock/subpartition/partition and the motion candidate of an implicit motion refinement for a second subblock/subpartition/partition of the video unit may be allowed to be same.
   c. For example, the motion candidate of an explicit motion refinement for a first subblock/subpartition/partition and the motion candidate of an explicit motion refinement for a second subblock/subpartition/partition of the video unit may be allowed to be same.
      a. Alternatively, the motion candidate of an explicit motion refinement for a first subblock/subpartition/partition and the motion candidate of an explicit motion refinement for a second subblock/subpartition/partition of the video unit may NOT be allowed to be same.
   d. For example, when motion candidates of two subblocks/subpartitions/partitions of a video unit is allowed to be same,
      a. Same motion candidates may be used for all subblocks/subpartitions/partitions of a video unit.
      b. Same motion candidates may be used for at least two subblocks/subpartitions/partitions of a video unit.
      c. Motion candidate index of at least one subblock/subpartition/partition of the video block may be NOT signalled but inferred.
      d. The number of signalled motion candidate index may be less than the number of subblocks/subpartitions/partitions of the video unit.
         i. For example, only one motion candidate index of a specific prediction method may be signalled for the entire video unit.
      e. Whether to signal or infer a motion candidate index may be dependent on a syntax element
         i. For example, a syntax flag indicating whether same candidate is used for all subblocks/subpartitions/partitions of the video unit).
         ii. For example, a syntax parameter indicating whether same candidate is used for the specified subblocks/subpartitions/partitions of the video unit.
      f. The motion candidate index of each subblock/subpartition/partition may be signaled independently (e.g., without depending on each other).
   e. For example, when motion candidates of two subblocks/subpartitions/partitions of a video unit are required to be different,
      a. Same motion candidate is NOT allowed for different subblocks/subpartitions/partitions of a video unit.
      b. The motion candidate index of each subblock/subpartition/partition may be signaled independently (e.g., without depending on each other).
      c. The coded/signalled value of the motion candidate index of a second subblock/subpartition/partition may be less then the motion candidate index used in the decoding process.
         i. How to covert a motion candidate index (in the decoding process) to a signalled motion candidate index (coded in the bitstream) may be dependent on the relationship between the motion candidate index of the first subblock/subpartition/partition and the motion candidate index of the second subblock/subpartition/partition.
   f. For example, the above mentioned “implicit motion refinement” may refer to TM-based method, or any other decoder-side motion refinement approach.
   g. For example, the above mentioned “explicit motion refinement” may refer to a motion-vector-difference-based (MMVD-based) method, or any other motion refinement approach that explicitly signal the motion difference information from encoder to decoder.

### General Claims

1. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
   1) For example, the disclosed methods may refer to template-matching-based (TM-based) motion refinement for GPM (or CIIP, or MHP, and etc.).
   2) For example, the disclosed methods may refer to motion-vector-difference-based (MMVD-based) method for GPM (or CIIP, or MHP, and etc.).
   3) For example, the presence of the signalled syntax elements may be dependent on the width and/or height of the picture/slice.
2. Whether to and/or how to apply the disclosed methods above may be signalled at PB/TB/CB/PU/TU/CU/VPDU/CTU/CTU row/slice/tile/sub-picture/other kinds of region contain more than one sample or pixel.
3. Whether to and/or how to apply the disclosed methods above may be dependent on coded information, such as block size, colour format, single/dual tree partitioning, colour component, slice/picture type.

### 4 PROBLEMS

There are several issues in the existing video coding techniques, which would be further improved for higher coding gain.
(1) The existing CIIP only combined Planar/PDPC with regular merge prediction, which may be extended to have more variants.
(2) For CIIP block and its variants, how to apply BCW, LIC, half-pel interpolation filter may be redesigned.
(3) The motion information and predictions of CIIP and its variants could be further refined.
(4) The existing CIIP is not allowed to be coded as SKIP mode, which may be improved.
(5) The existing MMVD only allows two base merge candidates for both SKIP mode and non-SKIP mode, which may be improved.

### 5 EMBODIMENTS OF THE PRESENT DISCLOSURE

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

In embodiments of the present disclosure, regarding “a block coded with mode N”, here “mode N” may be a prediction mode (e.g., MODE_INTRA, MODE_INTER, MODE_PLT, MODE_IBC, and etc.), or a coding technique (e.g., AMVP, Merge, SMVD, BDOF, PROF, DMVR, AMVR, TM, Affine, CIIP, GPM, MMVD, BCW, HMVP, SbTMVP, TIMD, DIMD, and etc.).

“CIIP” in embodiments of the present disclosure may refer to any coding tool that combines/blends more than one prediction/composition/hypothesis into one prediction result for later reconstruction process. For example, “CIIP” in embodiments of the present disclosure may refer to any multiple hypothesis prediction coding tools/techniques such as regular CIIP, CIIP PDPC, extended CIIP, MHP, GPM, and etc. Moreover, a composition/hypothesis of CIIP/MHP/GPM may be INTER mode coded, or INTRA mode coded, or any other prediction mode other than INTER and INTRA modes. Moreover, “CIIP” in embodiments of the present disclosure may not necessarily have to be a MERGE mode, e.g., it could be an AMVP mode, or a special prediction mode other than AMVP and MERGE.
1. Variants of CIIP modes are proposed wherein the CIIP mode may be based on a prediction block generated from AMVP prediction, or enhanced merge prediction, or other non-regular merge predictions.
   1) Furthermore, CIIP mode may be coded as a type of non-merge mode.
      a) For example, syntax elements related to CIIP mode may be signalled outside of the scope of merge data related syntax structure.
   2) For example, AMVP prediction such as regular AMVP, affine AMVP, SMVP, TM/DMVR/BDOF refined AMVP, or a variant of AMVP prediction, may be used to construct CIIP prediction.
   3) For example, enhanced merge prediction such as GEO, MMVD, affine, SbTMVP, TM/DMVR/BDOF refined merge, or a variant of merge prediction, may be used to construct CIIP prediction.
   4) For example, other predictions such as MHP, amvp-merge, and any other prediction method which is not exclusively based on AMVP or merge, may be used to construct CIIP prediction.
   5) For example, CIIP mode may blend an affine prediction and other type of prediction(s) together.
      a) For example, the affine prediction may be generated from inter affine merge mode.
      b) For example, the affine prediction may be generated from inter affine MMVD mode.
      c) For example, the affine prediction may be generated from inter affine AMVP mode.
   6) In one example, IBC prediction may be used to construct a CIIP prediction.
2. For example, adaptive merge list reordering (e.g., ARMC, AML) may be applied to the CIIP variants (e.g., CIIP with MMVD, CIIP with TM, CIIP with affine, CIIP with sbTMVP, MHP, and etc).
   1) Alternatively, adaptive merge list reordering may not be allowed for a certain CIIP variant.
   2) For example, adaptive merge list reordering may be applied to certain variants of CIIP but disallowed for others.
      a) E.g., it is allowed for, but not allowed to be applied to CIIP with affine prediction.
3. For example, a CIIP prediction may be generated based on coded information (e.g., BCW index, half-pel interpolation filter, LIC flag).
   1) For example, the CIIP prediction may be an intermediate prediction block which construct the final prediction of a certain CIIP variant such as CIIP with MMVD, CIIP with TM, CIIP with affine, CIIP with sbTMVP, and etc.
   2) For example, unlike regular merge based prediction block where BCW index is generally inherited from neighbor blocks, the BCW index may not be inherited for a CIIP prediction block (in such case the BCW index is set to a default value specifying no BCW is applied to the specified prediction block).
      a) Furthermore, a merge based prediction with BCW index indicating unequal weights between L0 prediction and L1 prediction, may not be used for a CIIP prediction block.
      b) Alternatively, BCW index of a merge based CIIP prediction block may be inherited from neighbor blocks (such like regular merge based prediction block).
   3) For example, unlike regular merge based prediction block where half-pel interpolation filter index is generally inherited from neighbor blocks, the half-pel interpolation filter index may not be inherited for a CIIP prediction block (in such case the half-pel interpolation filter index is set to a default value specifying no half-pel interpolation filter is applied to the specified prediction block).
      a) Furthermore, a merge based prediction using half-pel interpolation filter, may not be used for a CIIP prediction block.
      b) Alternatively, half-pel interpolation filter of a merge based CIIP prediction block may be inherited from neighbor blocks (such like regular merge based prediction block).
   4) For example, unlike regular merge based prediction block where LIC flag is generally inherited from neighbor blocks, the LIC flag may not be inherited for a CIIP prediction block (in such case the LIC flag is set to a default value specifying no LIC is applied to the specified prediction block).
      a) Furthermore, a merge based prediction using LIC, may not be used for a CIIP prediction block.
      b) Alternatively, LIC flag of a merge based CIIP prediction block may be inherited from neighbor blocks (such like regular merge based prediction block).
   5) For example, unlike AMVP based prediction block where a BCW index is signalled in the bitstream, a CIIP block may not signal BCW index.
      a) Furthermore, a AMVP predicted block with BCW index indicating unequal weights between L0 prediction and L1 prediction, may not be allowed to be used as a CIIP prediction block.
      b) Alternatively, BCW index may be signalled for a CIIP coded block.
   6) For example, unlike AMVP based prediction block where a half-pel interpolation index is signalled in the bitstream, a CIIP block may not signal a half-pel interpolation index.
      a) Furthermore, a AMVP predicted block generated by half-pel interpolation filter, may not be allowed to be used as a CIIP prediction block.
      b) Alternatively, a half-pel interpolation filter index may be signalled for a CIIP coded block.
   7) For example, unlike AMVP based prediction block where a LIC flag is signalled in the bitstream, a CIIP block may not signal a LIC flag.
      a) Furthermore, a AMVP predicted block generated by LIC, may not be allowed to be used as a CIIP prediction block.
      b) Alternatively, a LIC flag may be signalled for a CIIP coded block.
4. In one example, the weighting values to generate the final prediction for CIIP may depend on how the two predictions are generated.
   1) For example, the weighting values may depend on how the inter-prediction in CIIP is generated, such as by merge, or AMVP, or MMVD, sbTMVP, MHP or GEO, etc, or whether the inter-prediction is refined such as by BDOF or DMVR.
   2) For example, the weighting values may depend on how the intra-prediction in CIIP is generated, such as DC, Planar prediction, PDPC predictor, TIMD, DIMD, CCLM, MM-CCLM, etc.
5. In one example, a prediction information of CIIP may be further refined (such as template matching, DMVR, BDOF, MMVD, DIMD, TIMD, and etc.).
   1) For example, the motion vectors of a CIIP prediction unit may be further refined by template matching, DMVR, BDOF, MMVD, and etc.
   2) For example, the luma samples of CIIP prediction may be further refined by BDOF.
   3) For example, whether a CIIP prediction is further refined may be conditioned on whether the coded information of the prediction satisfies certain conditions.
      a) For example, whether to apply DMVR to CIIP or not, may follow the same rule of the condition of applying DMVR to regular merge mode.
      b) For example, whether to apply BDOF to CIIP or not, may follow the same rule of the condition of applying BDOF to regular merge mode.
      c) For example, only if a CIIP prediction is generated by a bi-directional prediction, the prediction may be further refined by DMVR/BDOF.
      d) For example, only if a CIIP prediction is generated by a bi-directional prediction, and the POC distances of L0 reference picture equal to the POC distance of L1 reference picture, the prediction may be further refined by DMVR/BDOF.
      e) For example, only if a CIIP prediction is generated by a bi-directional prediction with equal weight (BCW is not used), the prediction may be further refined by DMVR/BDOF.
      f) For example, only if a CIIP prediction is not generated by slice/picture level weighted prediction, the prediction may be further refined by DMVR/BDOF.
   4) Alternatively, template matching/DMVR/BDOF may not be allowed to apply to CIIP prediction unit and a certain CIIP variant (e.g., CIIP with MMVD, CIIP with TM, CIIP with affine, CIIP with sbTMVP, MHP, and etc).
6. In one example, the final prediction results of CIIP mode may be blended/fused from more than N (such as N=2) prediction blocks.
   1) For example, except a first prediction block and a second prediction block, a third prediction block may be further blended/fused to generate a final prediction block for CIIP mode.
   2) For example, a first prediction block may be generated from Intra prediction, DC, Planar prediction, PDPC predictor, TIMD, DIMD, CCLM, MM-CCLM, and etc.
   3) For example, a second prediction block may be generated from Inter regular Merge prediction, or a variant of merge prediction.
   4) For example, a third prediction block may be generated from AMVP prediction, enhanced merge prediction, or other predictions (as described in bullet 1.1, 1.2, and 1.3).
   5) The second prediction or the third prediction may be generated by IBC.
   6) Furthermore, weights to blend/fuse the multiple predictions may be pre-defined.
      a) Alternatively, weights may be adaptively determined by the coded information of neighbors and/or current immediate (such as prediction modes/methods, gradient information based on the prediction/reconstructed sample).
      b) Alternatively, weights may be determined based on signalled syntax element(s).
         i. For example, more than one weight sets may be predefined and a syntax element (e.g., an index) may be signaled at video unit level (e.g., block/slice/slice header/picture/picture header/sequence level) indicating that which weight set is used for this video unit.
      c) Moreover, weights may be sample based, or block based, or slice/picture/sequence based.
         i. For example, every sample may have its own weight.
         ii. For example, samples within a block may share a same weight.
         iii. For example, samples belong to a slice/picture/sequence may share a same weight.
7. In one example, SKIP mode may be allowed for a block coded with CIIP variant mode.
   1) For example, the CIIP variant mode may be a CIIP with MMVD, CIIP with TM, CIIP with affine, CIIP with sbTMVP, and etc.
   2) For example, the presence/signalling of CIIP related syntax elements may not depend on skip flag (e.g., not under the condition that the skip flag of the coding unit is equal to false).
8. For example, more than N (such as N=2) merge candidates may be allowed for an extended MMVD mode.
   1) For example, the extended MMVD mode may be the CIIP with MMVD.
   2) For example, the number of maximum allowed merge candidates for a MMVD coded video unit may be equal to the number of maximum allowed general merge candidates.
   3) For example, the signaled merge index of a MMVD coded video unit may be equal to a value greater than K (such as K=1).
   4) For example, only if a video unit is coded with SKIP mode (skip flag of this video unit is equal to true), the number of MMVD merge candidates is allowed to be greater than N.
      a) For example, only if a video unit is coded with SKIP mode, the signalled merge index is allowed to be greater than K (such as K=1).
      b) For example, in case that a MMVD coded video unit is coded as SKIP mode, a merge index may be signalled for the video unit. Otherwise, a merge flag may be signalled for the video unit.
   5) Alternatively, only if a video unit is coded with non-SKIP mode (skip flag of this video unit is equal to false), the number of MMVD merge candidates is allowed to be greater than N.
      a) For example, only if a video unit is coded with non-SKIP mode, the signalled merge index is allowed to be greater than K (such as K=1).
      b) For example, in case that a MMVD coded video unit is coded as non-SKIP mode, a merge index may be signalled for the video unit. Otherwise, a merge flag may be signalled for the video unit.
   6) Alternatively, only N (such as N=2) merge candidates may be allowed for CIIP MMVD mode, or regular TM mode, or CIIP TM mode, or GEO TM mode, or GEO MMVD mode.
   7) In one example, different numbers of base merge candidates may be allowed for different MMVD mode (different MMVD mode may refer to regular MMVD mode, CIIP MMVD mode, GEO MMVD mode, etc.)
9. For example, a virtual motion candidate generated from more than one motion vector though a certain operation (other than averaging operation) may be inserted to motion candidate list (e.g., AMVP or Merge candidate list).
   1) For example, N (such as N=2) motion candidates may be added up and right shifted by a pre-defined value K (K>1, such as K=2).
      a) For example, the N motion candidates may be based on merge candidates in the merge lists.
      b) For example, the two motion candidates may be the N two merge candidates in the merge lists.
      c) For example, the N motion candidates may be based on AMVP candidates in the AMVP list.
   2) For example, how to apply the claimed operation may depend on the prediction list (L0, L1) and/or the reference index.
      a) For example, the claimed operation may be done for L0 and L1, respectively.
         i. Alternatively, the claimed operation may be done for L0 only.
         ii. Alternatively, the claimed operation may be done for L1 only.
      b) For example, the claimed operation may be done in case the reference index is greater than X (such as X=0).
   3) For example, the above generated motion candidate may be used as a new motion candidate for a certain inter mode.
      a) For example, the certain inter mode may be regular AMVP mode, regular MERGE mode, GEO mode, GEO MMVD mode, GEO TM mode, CIIP mode, CIIP MMVD mode, CIIP TM mode, regular MMVD mode, MMVD-TM mode, MHP mode, Affine mode, AMVP-Merge mode, and etc.
   4) For example, the above generated motion candidate may be used to replace an existing motion candidate for a certain inter mode.
      a) For example, the existing motion candidate may be one of the motion candidates in the existing motion candidate list.

### General Claims

4. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
   1) For example, the presence of the signalled syntax elements may be dependent on the width and/or height of the picture/slice.
5. Whether to and/or how to apply the disclosed methods above may be signalled at PB/TB/CB/PU/TU/CU/VPDU/CTU/CTU row/slice/tile/sub-picture/other kinds of region contain more than one sample or pixel.
6. Whether to and/or how to apply the disclosed methods above may be dependent on coded information, such as block size, colour format, single/dual tree partitioning, colour component, slice/picture type.

Embodiments of the present disclosure are related to CIIP variants. As used herein, the terms “video unit” or “coding unit” or “block” used herein may refer to one or more of: a color component, a sub-picture, a slice, a tile, a coding tree unit (CTU), a CTU row, a group of CTUs, a coding unit (CU), a prediction unit (PU), a transform unit (TU), a coding tree block (CTB), a coding block (CB), a prediction block(PB), a transform block (TB), a block, a sub-block of a block, a sub-region within the block, or a region that comprises more than one sample or pixel. A block may be rectangular or non-rectangular.

Regarding “a block coded with mode N”, the term “mode N” may be a prediction mode (e.g., MODE_INTRA, MODE_INTER, MODE_PLT, MODE_IBC, and etc.), or a coding technique (e.g., AMVP, Merge, SMVD, BDOF, PROF, DMVR, AMVR, TM, Affine, CIIP, GPM, MMVD, BCW, HMVP, SbTMVP, TIMD, DIMD, and the like).

The term “CIIP” used herein may refer to any coding tool that combines/blends more than one prediction/composition/hypothesis into one prediction result for later reconstruction process. For example, “CIIP” in embodiments of the present disclosure may refer to any multiple hypothesis prediction coding tools/techniques such as regular CIIP, CIIP PDPC, extended CIIP, MHP, GPM, and etc. Moreover, a composition/hypothesis of CIIP/MHP/GPM may be INTER mode coded, or INTRA mode coded, or any other prediction mode other than INTER and INTRA modes. Moreover, “CIIP” in embodiments of the present disclosure may not necessarily have to be a MERGE mode, e.g., it could be an AMVP mode, or a special prediction mode other than AMVP and MERGE.

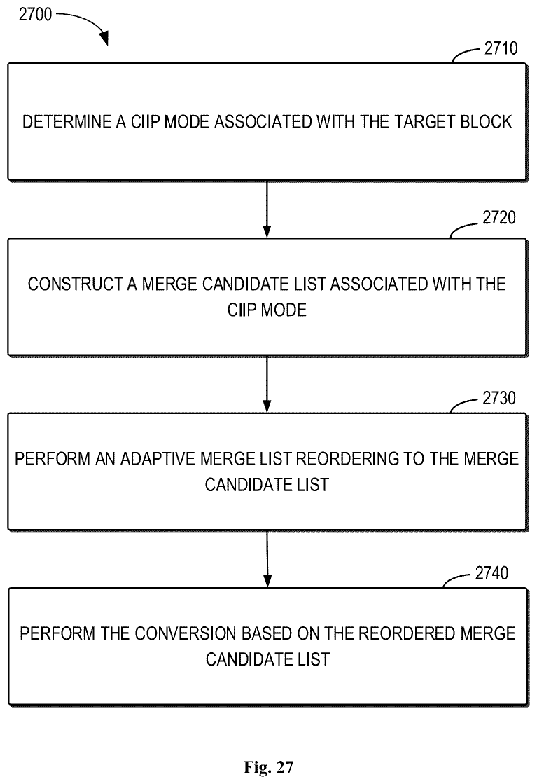

FIG. 27 illustrates a flowchart of a method 2700 for video processing in accordance with some embodiments of the present disclosure. The method 2700 may be implemented during a conversion between a video unit and a bitstream of the video unit.

At block 2710, during a conversion between a target block of a video and a bistream of the target block, a combined inter and intra prediction (CIIP) mode associated with the target block is determined. In some embodiments, the CIIP mode may comprise one or more of: a CIIP with merge mode with motion vector differences (MMVD), a CIIP with template matching (TM), a CIIP with affine prediction, a CIIP with subblock-based temporal motion vector prediction (SbTMVP), or a multi-hypothesis prediction (MHP).

At block 2720, a merge candidate list associated with the CIIP mode is constructed. At block 2730, an adaptive merge list reordering is performed to the merge candidate list associated with the CIIP mode. In some embodiments, the adaptive merge list reordering may refer to an adaptive reordering of merge candidates (ARMC). Alternatively, or in addition, the adaptive merge list reordering may refer to an adaptive merge list (AML). In some embodiments, the adaptive merge list reordering may not be allowed to be applied to a CIIP variant. In some other embodiments, the adaptive merge list reordering may be applied to a first CIIP variant, and the adaptive merge list reordering may not be allowed to be applied to a second CIIP variant. For example, if the second CIIP variant may be a CIIP with affine prediction, the adaptive merge list reordering may not be allowed to be applied to the CIIP with affine prediction.

At block 2740, the conversion is performed based on the reordered merge candidate list. In some embodiments, the conversion may comprise encoding the video unit into the bitstream. In some embodiments, the conversion may comprise decoding the video unit from the bitstream.

According to embodiments of the present disclosure, more CIIP variants are proposed. For CIIP block and its variants, a more efficient approach regarding how to apply BCW, LIC, half-pel interpolation filter is designed. Compared with the conventional solution, some embodiments of the present disclosure can advantageously improve the coding efficiency.

Implementations of the present disclosure can be described in view of the following clauses, the features of which can be combined in any reasonable manner.

In some embodiment, the CIIP may be based on a prediction block associated with the target block. For example, the prediction block may be generated from one of: an advanced motion vector prediction (AMVP), an enhanced merge prediction, or a non-regular merge prediction.

In some embodiment, the CIIP mode may be coded as a type of non-merge mode. For example, a syntax element related to the CIIP mode may be indicated outside of a scope of merge data related syntax structure.

In some embodiment, the AMVP may be used to construct a CIIP prediction associated with the target block. For example, the AMVP may comprise at least one of: a regular AMVP, an affine AMVP, a spatial motion vector prediction (SMVP) refined AMVP, a template matching (TM) refined AMVP, a decoder side motion vector refinement (DMVR) refined AMVP, a bi-directional optical flow (BDOF) refined AMVP, or a variant of AMVP prediction. For example, AMVP prediction such as regular AMVP, affine AMVP, SMVP, TM/DMVR/BDOF refined AMVP, or a variant of AMVP prediction, may be used to construct CIIP prediction.

In some embodiment, the enhanced merge prediction may be used to construct a CIIP prediction associated with the target block. For example, the enhanced merge prediction may comprise at least one of: a geometric merge mode, a merge mode with motion vector difference (MMVD), an affine merge prediction, a subblock-based temporal motion vector prediction (SbTMVP), a TM refined merge, a DMVR refined merge, a BDOF refined merge, or a variant of merge prediction. For example, enhanced merge prediction such as GEO, MMVD, affine, SbTMVP, TM/DMVR/BDOF refined merge, or a variant of merge prediction, may be used to construct CIIP prediction.

In some embodiments, the non-regular merge prediction may be used to construct a CIIP prediction associated with the target block. For example, the non-regular merge prediction may comprise: a MHP, or a AMVP-merge. For example, other predictions such as MHP, amvp-merge, and any other prediction method which is not exclusively based on AMVP or merge, may be used to construct CIIP prediction.

In some embodiments, the CIIP mode may blend an affine prediction and a different type of prediction together. For example, the affine prediction may be generated from an inter affine merge mode. In some embodiments, the affine prediction may be generated from an inter affine MMVD mode. In some other embodiments, the affine prediction may be generated from an inter affine AMVP mode. For example, an intra block copy (IBC) prediction may be used to construct a CIIP prediction.

In some embodiments, a CIIP prediction may be generated based on coding information. For example, the coding information may comprise one or more of: BCW index, half-pel interpolation filter, or a local illumination compensation (LIC) flag.

In some embodiments, the CIIP prediction may be an intermediate prediction which constructs a final predication of a CIIP variant. For example, the CIIP variant may comprise one of: a CIIP with MMVD, a CIIP with TM, a CIIP with affine, or a CIIP with sbTMVP.

In some embodiments, a bi-prediction with coding unit (CU)-level weight (BCW) index may not be inherited for a CIIP prediction block associated with the target block. For example, the BCW index may be set to a default value which specifies no BCW is applied to a specified prediction block. For example, unlike regular merge based prediction block where BCW index is generally inherited from neighbor blocks, the BCW index may not be inherited for a CIIP prediction block.

In some embodiments, a merge based prediction with BCW index indicating unequal weights between L0 prediction and L1 prediction may not be used for the CIIP prediction block. Alternatively, a BCW index of a merge based CIIP prediction block may be inherited from a set of neighbor blocks.

In some embodiments, a half-pel interpolation filter index may not be inherited for a CIIP prediction block associated with the target block. For example, the half-pel interpolation filter index may be set to a default value which specifies no half-pel interpolation filter is applied to a specified prediction block. For example, unlike regular merge based prediction block where half-pel interpolation filter index is generally inherited from neighbor blocks, the half-pel interpolation filter index may not be inherited for a CIIP prediction block.

In some embodiments, a merge based prediction using the half-pel interpolation filter may not be used for the CIIP prediction block. Alternatively, a half-pel interpolation filter index of a merge based CIIP prediction block may be inherited for a CIIP prediction block associated with the target block.

In some embodiments, a local illumination compensation (LIC) flag may not be inherited for a CIIP prediction block associated with the target block. For example, the LIC flag may be set to a default value which specifies that no LIC is applied to a specified prediction block. For example, unlike regular merge based prediction block where LIC flag is generally inherited from neighbor blocks, the LIC flag may not be inherited for a CIIP prediction block.

In some embodiments, a merge based prediction using LIC may not be used for the CIIP prediction block. Alternatively, a LIC flag of a merge based CIIP prediction block may be inherited from a set of neighbor blocks.

In some embodiments, a BCW index may not be indicated for the target block which is a CIIP coded block. For example, unlike AMVP based prediction block where a BCW index is signalled in the bitstream, a CIIP block may not signal BCW index. In this case, in some embodiments, an AMVP predicted block with BCW indicating unequal weights between L0 prediction and L1 prediction may not be allowed to be used as a CIIP prediction block. Alternatively, a BCW index may be indicated for the target block which is a CIIP coded block.

In some embodiments, a half-pel interpolation index may not be indicated for the target block which is a CIIP coded block. For example, unlike AMVP based prediction block where a half-pel interpolation index is signalled in the bitstream, a CIIP block may not signal a half-pel interpolation index. In this case, in some embodiments, an AMVP predicted block generated by half-pel interpolation filter may not be allowed to be used as a CIIP prediction block. Alternatively, a half-pel interpolation index may be indicated for the target block which is a CIIP coded block.

In some embodiments, a LIC flag may not be indicated for the target block which is a CIIP coded block. For example, unlike AMVP based prediction block where a LIC flag is signalled in the bitstream, a CIIP block may not signal a LIC flag. In this case, in some embodiments, an AMVP predicted block generated by LIC may not be allowed to be used as a CIIP prediction block. Alternatively, a LIC flag may be indicated for the target block which is a CIIP coded block.

In some embodiments, a weighting value to generate a final prediction for CIIP depends on how intra-prediction and inter-prediction may be generated. For example, the weighting value may depend on at least one of: how the inter-prediction is generated, or how the intra-prediction is refined. In some embodiments, the weighting value may depend on how the intra-prediction is generated.

In some embodiments, prediction information of a CIIP prediction block may be further refined. In this case, the prediction information may comprise at least one of: template matching, DMVR, BDOF, MMVD, DIMD, or TIMD.

In some embodiments, a set of motion vectors of the CIIP prediction block may further be refined by at least one of: template matching, DMVRM, BDOF, or MMVD. In some other embodiments, a set of luma samples of the CIIP prediction block may further be refined by BDOF. In some other embodiments, whether the CIIP prediction block is further refined may depend on whether coding information of the CIIP prediction block satisfies a condition.

In some embodiments, whether DMVR is applied to the CIIP prediction block may depend on the condition for applying DMVR to a regular merge mode. In some other embodiments, whether BDOF is applied to the CIIP prediction block may depend on the condition for applying BDOF to a regular merge mode. In some embodiments, if the CIIP prediction block is generated by a bi-directional prediction, the CIIP prediction block may further be refined by one of: DMVR or BDOF.

In some embodiments, if the CIIP prediction block is generated by a bi-directional prediction and a first picture order coding (POC) distance of L0 reference picture equals to a second POC distance of L1 reference picture, the CIIP prediction block may further be refined by one of: DMVR or BDOF. In other embodiments, if the CIIP prediction block is generated by a bi-directional prediction with equal weight, the CIIP prediction block may further be refined by one of: DMVR or BDOF. Alternatively, if the CIIP prediction block is not generated by a slice level weighted prediction or a picture level weighted prediction, the CIIP prediction block may further be refined by one of: DMVR or BDOF.

In some embodiments, at least one of the followings may not be allowed to apply to a CIIP prediction block and a CIIP variant: template matching, DMVR, or BDOF. In this case, in some embodiments, the CIIP variant may comprise at least one of: a CIIP with MMVD, a CIIP with TM, a CIIP with affine prediction, a CIIP with sbTMVP, or MHP.

In some embodiments, a final prediction of CIIP mode may be fused from a plurality of prediction blocks. For example, the plurality of prediction blocks may comprise a first prediction block, a second prediction block, or a third prediction block. In some embodiments, the first prediction block may be generated from at least one of: an intra prediction, a direct currency (DC), a planar prediction, a position dependent intra prediction combination (PDPC) predictor, a TIMD, a DIMD, a cross-component linear model (CCLM), or a multi-model CCLM (MM-CCLM). In some embodiments, the second prediction block may be generated from at least one of: an inter regular merge prediction, or a variant of merge prediction. In some embodiments, the third prediction block may be generated from at least one of: an AMVP prediction, an enhance merge prediction, or a non-regular merge prediction.

In some embodiments, at least one of the second prediction block or the third prediction block may be generated by IBC. In some embodiments, a set of weights for fusing the plurality of prediction blocks may be pre-defined.

In some embodiments, a set of weights for fusing the plurality of prediction blocks may be determined based on coding information of at least one of: a neighbor immediate or a current immediate. For example, the coding information may comprise at least one of: a prediction mode, or gradient information based on a prediction of the target block.

In some embodiments, a set of weights for fusing the plurality of prediction blocks may be determined based on a set of syntax elements. For example, multiple sets of weights may be predefined and a syntax element that indicates which weight set is used may be indicated at a video unit level. In some embodiments, the video unit level may comprise one of: a block level, a slice level, a slice header level, a picture level, a picture header level, or a sequence level.

In some embodiments, a set of weights for fusing the plurality of prediction blocks may be one of: sample based, block based, slice based, picture based, or sequence based. For example, cach sample may have a weight. In some embodiments, samples within a block may have a same weight. In some other embodiments, samples belonging to one of: a slice, a picture, or a sequence may have a same weight.

In some embodiments, a skip mode may be allowed for the target clock which is coded with a CIIP variant. For example, the CIIP variant may comprise one of: a CIIP with MMVD, a CIIP with TM, a CIIP with affine prediction, or a CIIP with sbTMVP. In some embodiments, a CIIP related syntax element does not depend on a skip flag.

In some embodiments, an indication of whether to and/or how to apply the adaptive merge list reordering may be indicated at one of the followings: sequence level, group of pictures level, picture level, slice level, or tile group level. In some embodiments, an indication of whether to and/or how to apply the coding tool may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to apply the adaptive merge list reordering may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to apply the adaptive merge list reordering may be determined based on coded information of the target block. The coded information may include at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, a combined inter and intra prediction (CIIP) mode associated with a target block may be determined. A merge candidate list associated with the CIIP mode is constructed. An adaptive merge list reordering may be performed to the merge candidate list associated with the CIIP mode. A bitstream of the target block may be generated based on the final predicted signal for the video unit.

In some embodiments, a combined inter and intra prediction (CIIP) mode associated with a target block may be determined. A merge candidate list associated with the CIIP mode may be constructed. A bitstream of the target block may be generated based on the reordered merge candidate list and stored in a non-transitory computer-readable recording medium.

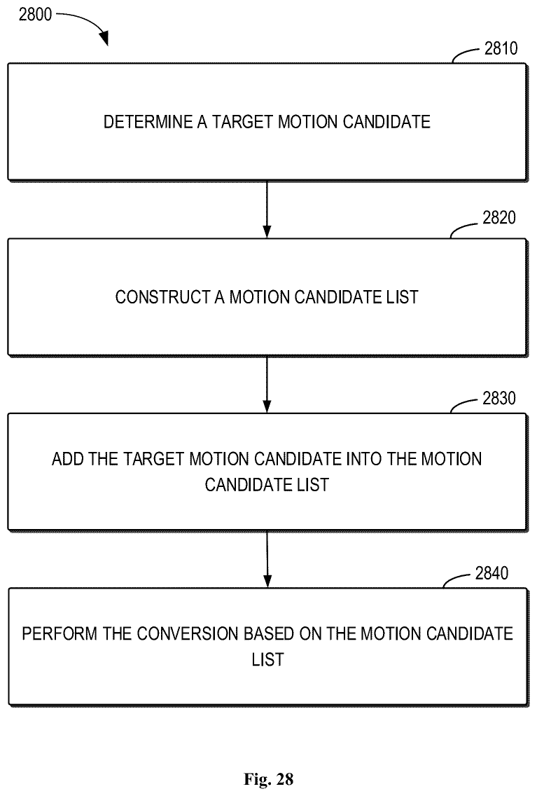

FIG. 28 illustrates a flowchart of a method 2800 for video processing in accordance with some embodiments of the present disclosure. The method 2800 may be implemented during a conversion between a video unit and a bitstream of the video unit.

At block 2810, during a conversion between a target block of a video and a bitstream of the target block, a target motion candidate is determined based on a plurality of motion vectors using a predetermined operation.

At block 2820, a motion candidate list for the target block is constructed. At block 2830, the target motion candidate is added into the motion candidate list.

At block 2840, the conversion is performed based on the motion candidate list. In some embodiments, the conversion may comprise encoding the video unit into the bitstream. In some embodiments, the conversion may comprise decoding the video unit from the bitstream.

Compared with the conventional solution, some embodiments of the present disclosure can advantageously improve the coding efficiency.

Implementations of the present disclosure can be described in view of the following clauses, the features of which can be combined in any reasonable manner.

In some embodiments, a plurality of motion candidates may be added up and right shifted by a pre-defined value which is larger than a predetermined number. For example, the plurality of motion candidates may be based on merge candidates in a merge candidate list. In some embodiments, the plurality of motion candidates may be a plurality of merge candidates in a merge candidate list. Alternatively, the plurality of motion candidates may be based on AMVP candidates in a AMVP candidate list.

In some embodiments, how the predetermined operation is applied may depend on at least one of: prediction lists comprising L0 and L1 or a reference index. For example, in some embodiments, the predetermined operation may be applied to L0 and L1, respectively. Alternatively, the predetermined operation may be applied to L0. In some other embodiments, the predetermined operation may be applied to L1.

In some embodiments, if the reference index is larger than a predetermine number, the predetermined operation may be applied. In some embodiments, the target motion candidate may be used as a new motion candidate for an inter mode. For example, the inter mode may comprise at least one of: a regular AMVP mode, a regular merge mode, a geometric merge mode, a geometric MMVD mode, a geometric template matching (TM) mode, a CIIP mode, a CIIP MMVD mode, a CIIP TM mode, a regular MMVD mode, a MMVD-TM mode, a MHP mode, an affine mode, or an AMVP-merge mode.

In some embodiments, the target motion candidate may be used to replace an existing motion candidate for an inter mode. In some embodiments, the existing motion candidate may be one of motion candidates in an existing motion candidate list.

In some embodiments, an indication of whether to and/or how to add the target motion candidate may be indicated at one of the followings: sequence level, group of pictures level, picture level, slice level, or tile group level.

In some embodiments, an indication of whether to and/or how to add the target motion candidate may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to add the target motion candidate may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to add the target motion candidate may be determined based on coded information of the target block. The coded information may include at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, a target motion candidate may be determined based on a plurality of motion vectors using a predetermined operation. A motion candidate list may be constructed for the target block. The target motion candidate may be added into the motion candidate list. A bitstream of the target block may be generated based on the motion candidate list.

In some embodiments, a target motion candidate may be determined based on a plurality of motion vectors using a predetermined operation. A motion candidate list may be constructed for the target block. The target motion candidate may be added into the motion candidate list. A bitstream of the target block may be generated based on the motion candidate list and stored in a non-transitory computer-readable recording medium.

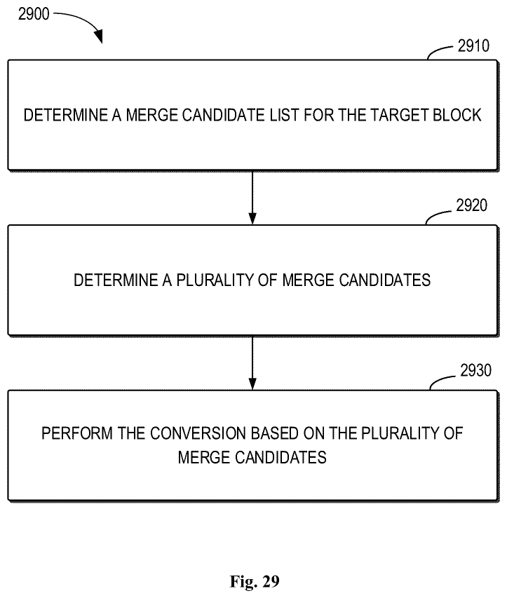

FIG. 29 illustrates a flowchart of a method 2900 for video processing in accordance with some embodiments of the present disclosure. The method 2900 may be implemented during a conversion between a video unit and a bitstream of the video unit.

At block 2910, during a conversion between a target block of a video and a bitstream of the target block, a merge candidate list for the target block. The target block is coded with a merge mode with motion vector differences (MMVD) mode. For example, the MMVD mode may comprise a combined intra and inter prediction (CIIP) with MMVD.

At block 2920, a plurality of merge candidates that are allowed for the MMVD mode is determined. At block 2930, the conversion is performed based on the plurality of merge candidates. In some embodiments, the conversion may comprise encoding the video unit into the bitstream. In some embodiments, the conversion may comprise decoding the video unit from the bitstream.

According to embodiments of the present disclosure, MMVD may allow more than two base merge candidates for both SKIP mode and non-SKIP mode. Compared with the conventional solution, some embodiments of the present disclosure can advantageously improve the coding efficiency.

Implementations of the present disclosure can be described in view of the following clauses, the features of which can be combined in any reasonable manner.

In some embodiments, the number of maximum allowed merge candidates for the target block may be equal to the number of maximum allowed general merge candidates. In some embodiments, a merge index of the target block may be equal to a value which is greater than a first predetermined number.

In some embodiments, if the target block is coded with a skip mode, the number of MMVD merge candidates may be allowed to be greater than a second predetermined number. In some embodiments, if the target block is coded with a skip mode, an indicated merge index may be allowed to be greater than a third predetermined number.

In some embodiments, if the target block is coded with a skip mode, a merge index may be indicated for the target block. Alternatively, if the target block is not coded with the skip mode, a merge flag may be indicated for the target block.

In some embodiments, if the target block is coded with a non-skip mode, the number of MMVD merge candidates may be allowed to be greater than a fourth predetermined number. In some embodiments, if the target block is coded with a non-skip mode, an indicated merge index may be allowed to be greater than a fifth predetermined number.

In some embodiments, if the target block is coded with a non-skip mode, a merge index may be indicated for the target block. Alternatively, if the target block is not coded with the non-skip mode, a merge flag may be indicated for the target block.

In some embodiments, only a sixth predetermined number of merge candidates may be allowed for at least one of: a CIIP MMVD mode, a regular TM mode, a CIIP TM mode, a geometric TM mode, or a geometric MMVD mode.

In some embodiments, different numbers of base merge candidates may be allowed for different MMVD modes. For example, the different MMVD modes may comprise at least one of: a regular MMVD mode, a CIIP MMVD mode, or a geometric MMVD mode.

In some embodiments, an indication of whether to and/or how to determine the plurality of merge candidates that are allowed for the MMVD mode may be indicated at one of the followings: sequence level, group of pictures level, picture level, slice level, or tile group level.

In some embodiments, an indication of whether to and/or how to determine the plurality of merge candidates that are allowed for the MMVD mode may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to determine the plurality of merge candidates that are allowed for the MMVD mode may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether and/or how to determine the plurality of merge candidates that are allowed for the MMVD mode may be determined based on coded information of the target block. The coded information may comprise at least one of: the coding mode, a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, a merge candidate list may be determined for the target block which is coded with a merge mode with motion vector differences (MMVD) mode. A plurality of merge candidates that are allowed for the MMVD mode may be determined. A bitstream of the target block may be generated based on the plurality of merge candidates.

In some embodiments, a merge candidate list may be determined for the target block which is coded with a merge mode with motion vector differences (MMVD) mode. A plurality of merge candidates that are allowed for the MMVD mode may be determined. A bitstream of the target block may be generated based on the plurality of merge candidates and stored in a non-transitory computer-readable recording medium.

Embodiments of the present disclosure can be implemented separately. Alternatively, embodiments of the present disclosure can be implemented in any proper combinations. Implementations of the present disclosure can be described in view of the following clauses, the features of which can be combined in any reasonable manner.
Clause 1. A method of video processing, comprising: determining, during a conversion between a target block of a video and a bitstream of the target block, a combined inter and intra prediction (CIIP) mode associated with the target block; constructing a merge candidate list associated with the CIIP mode; performing an adaptive merge list reordering to the merge candidate list associated with the CIIP mode; and performing the conversion based on the reordered merge candidate list.
Clause 2. The method of clause 1, wherein the CIIP mode comprises at least one of: a CIIP with merge mode with motion vector differences (MMVD), a CIIP with template matching (TM), a CIIP with affine prediction, a CIIP with subblock-based temporal motion vector prediction (SbTMVP), or a multi-hypothesis prediction (MHP).
Clause 3. The method of clause 1, wherein the adaptive merge list reordering is not allowed to be applied to a CIIP variant.
Clause 4. The method of clause 1, wherein the adaptive merge list reordering is applied to a first CIIP variant, and wherein the adaptive merge list reordering is not allowed to be applied to a second CIIP variant.
Clause 5. The method of clause 4, wherein the second CIIP variant is a CIIP with affine prediction, and the adaptive merge list reordering is not allowed to be applied to the CIIP with affine prediction.
Clause 6. The method of clause 1, wherein the CIIP is based on a prediction block associated with the target block.
Clause 7. The method of clause 6, wherein the prediction block is generated from one of: an advanced motion vector prediction (AMVP), an enhanced merge prediction, or a non-regular merge prediction.
Clause 8. The method of clause 1, wherein the CIIP mode is coded as a type of non-merge mode.
Clause 9. The method of clause 8, wherein a syntax element related to the CIIP mode is indicated outside of a scope of merge data related syntax structure.
Clause 10. The method of clause 7, wherein the AMVP is used to construct a CIIP prediction associated with the target block.
Clause 11. The method of clause 10, wherein the AMVP comprises at least one of: a regular AMVP, an affine AMVP, a spatial motion vector prediction (SMVP) refined AMVP, a template matching (TM) refined AMVP, a decoder side motion vector refinement (DMVR) refined AMVP, a bi-directional optical flow (BDOF) refined AMVP, or a variant of AMVP prediction.
Clause 12. The method of clause 7, wherein the enhanced merge prediction is used to construct a CIIP prediction associated with the target block.
Clause 13. The method of clause 12, wherein the enhanced merge prediction comprises at least one of: a geometric merge mode, a merge mode with motion vector difference (MMVD), an affine merge prediction, a subblock-based temporal motion vector prediction (SbTMVP), a TM refined merge, a DMVR refined merge, a BDOF refined merge, or a variant of merge prediction.
Clause 14. The method of clause 7, wherein the non-regular merge prediction is used to construct a CIIP prediction associated with the target block.
Clause 15. The method of clause 14, wherein the non-regular merge prediction comprises: a MHP, or a AMVP-merge.
Clause 16. The method of clause 1, wherein the CIIP mode blends an affine prediction and a different type of prediction together.
Clause 17. The method of clause 16, wherein the affine prediction is generated from an inter affine merge mode.
Clause 18. The method of clause 16, wherein the affine prediction is generated from an inter affine MMVD mode.
Clause 19. The method of clause 16, wherein the affine prediction is generated from an inter affine AMVP mode.
Clause 20. The method of clause 1, wherein an intra block copy (IBC) prediction is used to construct a CIIP prediction.
Clause 21. The method of clause 1, wherein a CIIP prediction is generated based on coding information.
Clause 22. The method of clause 21, wherein the CIIP prediction is an intermediate prediction which constructs a final predication of a CIIP variant.
Clause 23. The method of clause 22, wherein the CIIP variant comprises one of: a CIIP with MMVD, a CIIP with TM, a CIIP with affine, or a CIIP with sbTMVP.
Clause 24. The method of clause 1, wherein a bi-prediction with coding unit (CU)-level weight (BCW) index is not inherited for a CIIP prediction block associated with the target block.
Clause 25. The method of clause 24, wherein the BCW index is set to a default value which specifies no BCW is applied to a specified prediction block.
Clause 26. The method of clause 24, wherein a merge based prediction with BCW index indicating unequal weights between L0 prediction and L1 prediction is not used for the CIIP prediction block.
Clause 27. The method of clause 1, wherein a BCW index of a merge based CIIP prediction block is inherited from a set of neighbor blocks.
Clause 28. The method of clause 1, wherein a half-pel interpolation filter index is not inherited for a CIIP prediction block associated with the target block.
Clause 29. The method of clause 28, wherein the half-pel interpolation filter index is set to a default value which specifies no half-pel interpolation filter is applied to a specified prediction block.
Clause 30. The method of clause 28, wherein a merge based prediction using the half-pel interpolation filter is not used for the CIIP prediction block.
Clause 31. The method of clause 1, wherein a half-pel interpolation filter index of a merge based CIIP prediction block is inherited for a CIIP prediction block associated with the target block.
Clause 32. The method of clause 1, wherein a local illumination compensation (LIC) flag is not inherited for a CIIP prediction block associated with the target block.
Clause 33. The method of clause 32, wherein the LIC flag is set to a default value which specifies that no LIC is applied to a specified prediction block.
Clause 34. The method of clause 33, wherein a merge based prediction using LIC is not used for the CIIP prediction block.
Clause 35. The method of clause 1, wherein a LIC flag of a merge based CIIP prediction block is inherited from a set of neighbor blocks.
Clause 36. The method of clause 1, wherein a BCW index is not indicated for the target block which is a CIIP coded block.
Clause 37. The method of clause 36, wherein an AMVP predicted block with BCW indicating unequal weights between L0 prediction and L1 prediction is not allowed to be used as a CIIP prediction block.
Clause 38. The method of clause 1, wherein a BCW index is indicated for the target block which is a CIIP coded block.
Clause 39. The method of clause 1, wherein a half-pel interpolation index is not indicated for the target block which is a CIIP coded block.
Clause 40. The method of clause 39, wherein an AMVP predicted block generated by half-pel interpolation filter is not allowed to be used as a CIIP prediction block.
Clause 41. The method of clause 1, wherein a half-pel interpolation index is indicated for the target block which is a CIIP coded block.
Clause 42. The method of clause 1, wherein a LIC flag is not indicated for the target block which is a CIIP coded block.
Clause 43. The method of clause 42, wherein an AMVP predicted block generated by LIC is not allowed to be used as a CIIP prediction block.
Clause 44. The method of clause 1, wherein a LIC flag is indicated for the target block which is a CIIP coded block.
Clause 45. The method of clause 1, wherein a weighting value to generate a final prediction for CIIP depends on how intra-prediction and inter-prediction are generated.
Clause 46. The method of clause 45, wherein the weighting value depends on at least one of: how the inter-prediction is generated, or how the intra-prediction is refined.
Clause 47. The method of clause 45, wherein the weighting value depends on how the intra-prediction is generated.
Clause 48. The method of clause 1, wherein prediction information of a CIIP prediction block is further refined, and wherein the prediction information comprises at least one of: template matching, DMVR, BDOF, MMVD, DIMD, or TIMD.
Clause 49. The method of clause 48, wherein a set of motion vectors of the CIIP prediction block is further refined by at least one of: template matching, DMVRM, BDOF, or MMVD.
Clause 50. The method of clause 48, wherein a set of luma samples of the CIIP prediction block is further refined by BDOF.
Clause 51. The method of clause 48, wherein whether the CIIP prediction block is further refined depends on whether coding information of the CIIP prediction block satisfies a condition.
Clause 52. The method of clause 51, wherein whether DMVR is applied to the CIIP prediction block depends on the condition for applying DMVR to a regular merge mode.
Clause 53. The method of clause 51, wherein whether BDOF is applied to the CIIP prediction block depends on the condition for applying BDOF to a regular merge mode.
Clause 54. The method of clause 51, wherein if the CIIP prediction block is generated by a bi-directional prediction, the CIIP prediction block is further refined by one of: DMVR or BDOF.
Clause 55. The method of clause 51, wherein if the CIIP prediction block is generated by a bi-directional prediction and a first picture order coding (POC) distance of L0 reference picture equals to a second POC distance of L1 reference picture, the CIIP prediction block is further refined by one of: DMVR or BDOF.
Clause 56. The method of clause 51, wherein if the CIIP prediction block is generated by a bi-directional prediction with equal weight, the CIIP prediction block is further refined by one of: DMVR or BDOF.
Clause 57. The method of clause 51, wherein if the CIIP prediction block is not generated by a slice level weighted prediction or a picture level weighted prediction, the CIIP prediction block is further refined by one of: DMVR or BDOF.
Clause 58. The method of clause 1, wherein at least one of the followings is not allowed to apply to a CIIP prediction block and a CIIP variant: template matching, DMVR, or BDOF.
Clause 59. The method of clause 58, wherein the CIIP variant comprises at least one of: a CIIP with MMVD, a CIIP with TM, a CIIP with affine prediction, a CIIP with sbTMVP, or MHP.
Clause 60. The method of clause 1, wherein a final prediction of CIIP mode is fused from a plurality of prediction blocks.
Clause 61. The method of clause 60, wherein the plurality of prediction blocks comprises a first prediction block, a second prediction block, or a third prediction block.
Clause 62. The method of clause 61, wherein the first prediction block is generated from at least one of: an intra prediction, a direct currency (DC), a planar prediction, a position dependent intra prediction combination (PDPC) predictor, a TIMD, a DIMD, a cross-component linear model (CCLM), or a multi-model CCLM (MM-CCLM).
Clause 63. The method of clause 61, wherein the second prediction block is generated from at least one of: an inter regular merge prediction, or a variant of merge prediction.
Clause 64. The method of clause 61, wherein the third prediction block is generated from at least one of: an AMVP prediction, an enhance merge prediction, or a non-regular merge prediction.
Clause 65. The method of clause 61, wherein at least one of the second prediction block or the third prediction block is generated by IBC.
Clause 66. The method of clause 60, wherein a set of weights for fusing the plurality of prediction blocks are pre-defined.
Clause 67. The method of clause 60, wherein a set of weights for fusing the plurality of prediction blocks are determined based on coding information of at least one of: a neighbor immediate or a current immediate.
Clause 68. The method of clause 67, wherein the coding information comprises at least one of: a prediction mode, or gradient information based on a prediction of the target block.
Clause 69. The method of clause 60, wherein a set of weights for fusing the plurality of prediction blocks are determined based on a set of syntax elements.
Clause 70. The method of clause 69, wherein multiple sets of weights are predefined and a syntax element that indicates which weight set is used is indicated at a video unit level.
Clause 71. The method of clause 70, wherein the video unit level comprises one of: a block level, a slice level, a slice header level, a picture level, a picture header level, or a sequence level.
Clause 72. The method of clause 60, wherein a set of weights for fusing the plurality of prediction blocks is one of: sample based, block based, slice based, picture based, or sequence based.
Clause 73. The method of clause 72, wherein each sample has a weight.
Clause 74. The method of clause 72, wherein samples within a block have a same weight.
Clause 75. The method of clause 72, wherein samples belonging to one of: a slice, a picture, or a sequence have a same weight.
Clause 76. The method of clause 1, wherein a skip mode is allowed for the target clock which is coded with a CIIP variant.
Clause 77. The method of clause 76, wherein the CIIP variant comprises one of: a CIIP with MMVD, a CIIP with TM, a CIIP with affine prediction, or a CIIP with sbTMVP.
Clause 78. The method of clause 1, wherein a CIIP related syntax element does not depend on a skip flag.
Clause 79. The method of any of clauses 1-78, wherein an indication of whether to and/or how to apply the adaptive merge list reordering is indicated at one of the followings: sequence level, group of pictures level, picture level, slice level, or tile group level.
Clause 80. The method of any of clauses 1-78, wherein an indication of whether to and/or how to apply the adaptive merge list reordering is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.
Clause 81. The method of any of clauses 1-78, wherein an indication of whether to and/or how to apply the adaptive merge list reordering is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.
Clause 82. The method of any of clauses 1-78, further comprising: determining, based on coded information of the target block, whether and/or how to apply the adaptive merge list reordering, the coded information including at least one of: the coding mode, a block size, a colour format, a single and/or dual tree partitioning, a colour component, a slice type, or a picture type.
Clause 83. A method of video processing, comprising: determining, during a conversion between a target block of a video and a bitstream of the target block, a target motion candidate based on a plurality of motion vectors using a predetermined operation; constructing a motion candidate list for the target block; adding the target motion candidate into the motion candidate list; and performing the conversion based on the motion candidate list.
Clause 84. The method of clause 83, wherein a plurality of motion candidates are added up and right shifted by a pre-defined value which is larger than a predetermined number.
Clause 85. The method of clause 84, wherein the plurality of motion candidates are based on merge candidates in a merge candidate list.
Clause 86. The method of clause 84, wherein the plurality of motion candidates are a plurality of merge candidates in a merge candidate list.
Clause 87. The method of clause 84, wherein the plurality of motion candidates are based on AMVP candidates in a AMVP candidate list.
Clause 88. The method of clause 83, wherein how the predetermined operation is applied depends on at least one of: prediction lists comprising L0 and L1 or a reference index.
Clause 89. The method of clause 88, wherein the predetermined operation is applied to L0 and L1, respectively.
Clause 90. The method of clause 88, wherein the predetermined operation is applied to L0, or wherein the predetermined operation is applied to L1.
Clause 91. The method of clause 88, wherein if the reference index is larger than a predetermine number, the predetermined operation is applied.
Clause 92. The method of clause 83, wherein the target motion candidate is used as a new motion candidate for an inter mode.
Clause 93. The method of clause 92, wherein the inter mode comprises at least one of: a regular AMVP mode, a regular merge mode, a geometric merge mode, a geometric MMVD mode, a geometric template matching (TM) mode, a CIIP mode, a CIIP MMVD mode, a CIIP TM mode, a regular MMVD mode, a MMVD-TM mode, a MHP mode, an affine mode, or an AMVP-merge mode.
Clause 94. The method of clause 83, wherein the target motion candidate is used to replace an existing motion candidate for an inter mode.
Clause 95. The method of clause 94, wherein the existing motion candidate is one of motion candidates in an existing motion candidate list.
Clause 96. The method of any of clauses 83-95, wherein an indication of whether to and/or how to add the target motion candidate is indicated at one of the followings: sequence level, group of pictures level, picture level, slice level, or tile group level.
Clause 97. The method of any of clauses 83-95, wherein an indication of whether to and/or how to add the target motion candidate is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.
Clause 98. The method of any of clauses 83-95, wherein an indication of whether to and/or how to add the target motion candidate is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.
Clause 99. The method of any of clauses 83-95, further comprising: determining, based on coded information of the target block, whether and/or how to add the target motion candidate, the coded information including at least one of: the coding mode, a block size, a colour format, a single and/or dual tree partitioning, a colour component, a slice type, or a picture type.
Clause 100. A method of video processing, comprising: determining, during a conversion between a target block of a video and a bitstream of the target block, a merge candidate list for the target block which is coded with a merge mode with motion vector differences (MMVD) mode; determining a plurality of merge candidates that are allowed for the MMVD mode; and performing the conversion based on the plurality of merge candidates.
Clause 101. The method of clause 100, wherein the MMVD mode comprises a combined intra and inter prediction (CIIP) with MMVD.
Clause 102. The method of clause 100, wherein the number of maximum allowed merge candidates for the target block is equal to the number of maximum allowed general merge candidates.
Clause 103. The method of clause 100, wherein a merge index of the target block is equal to a value which is greater than a first predetermined number.
Clause 104. The method of clause 100, wherein if the target block is coded with a skip mode, the number of MMVD merge candidates is allowed to be greater than a second predetermined number.
Clause 105. The method of clause 100, wherein if the target block is coded with a skip mode, an indicated merge index is allowed to be greater than a third predetermined number.
Clause 106. The method of clause 100, wherein if the target block is coded with a skip mode, a merge index is indicated for the target block, and wherein if the target block is not coded with the skip mode, a merge flag is indicated for the target block.
Clause 107. The method of clause 100, wherein if the target block is coded with a non-skip mode, the number of MMVD merge candidates is allowed to be greater than a fourth predetermined number.
Clause 108. The method of clause 107, wherein if the target block is coded with a non-skip mode, an indicated merge index is allowed to be greater than a fifth predetermined number.
Clause 109. The method of clause 100, wherein if the target block is coded with a non-skip mode, a merge index is indicated for the target block, and wherein if the target block is not coded with the non-skip mode, a merge flag is indicated for the target block.
Clause 110. The method of clause 100, wherein only a sixth predetermined number of merge candidates is allowed for at least one of: a CIIP MMVD mode, a regular TM mode, a CIIP TM mode, a geometric TM mode, or a geometric MMVD mode.
Clause 111. The method of clause 100, wherein different numbers of base merge candidates are allowed for different MMVD modes.
Clause 112. The method of clause 111, wherein the different MMVD modes comprises at least one of: a regular MMVD mode, a CIIP MMVD mode, or a geometric MMVD mode.
Clause 113. The method of any of clauses 100-112, wherein an indication of whether to and/or how to determine the plurality of merge candidates that are allowed for the MMVD mode is indicated at one of the followings: sequence level, group of pictures level, picture level, slice level, or tile group level.
Clause 114. The method of any of clauses 100-112, wherein an indication of whether to and/or how to determine the plurality of merge candidates that are allowed for the MMVD mode is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.
Clause 115. The method of any of clauses 100-112, wherein an indication of whether to and/or how to determine the plurality of merge candidates that are allowed for the MMVD mode is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.
Clause 116. The method of any of clauses 100-112, further comprising: determining, based on coded information of the target block, whether and/or how to determine the plurality of merge candidates that are allowed for the MMVD mode, the coded information including at least one of: the coding mode, a block size, a colour format, a single and/or dual tree partitioning, a colour component, a slice type, or a picture type.
Clause 117. The method of any of clauses 1-116, wherein the conversion includes encoding the target block into the bitstream.
Clause 118. The method of any of clauses 1-116, wherein the conversion includes decoding the target block from the bitstream.
Clause 119. An apparatus for processing video data comprising a processor and a non-transitory memory with instructions thereon, wherein the instructions upon execution by the processor, cause the processor to perform a method in accordance with any of clauses 1-82, or any of clauses 83-99, or any of clauses 100-116.
Clause 120. A non-transitory computer-readable storage medium storing instructions that cause a processor to perform a method in accordance with any of clauses 1-82, or any of clauses 83-99, or any of clauses 100-116.
Clause 121. A non-transitory computer-readable recording medium storing a bitstream of a video which is generated by a method performed by a video processing apparatus, wherein the method comprises: determining a combined inter and intra prediction (CIIP) mode associated with a target block; constructing a merge candidate list associated with the CIIP mode; performing an adaptive merge list reordering to the merge candidate list associated with the CIIP mode; and generating a bitstream of the target block based on the CIIP mode.
Clause 122. A method for storing bitstream of a video, comprising: determining a combined inter and intra prediction (CIIP) mode associated with a target block; constructing a merge candidate list associated with the CIIP mode; performing an adaptive merge list reordering to the merge candidate list associated with the CIIP mode; generating a bitstream of the target block based on the CIIP mode; and storing the bitstream in a non-transitory computer-readable recording medium.
Clause 123. A non-transitory computer-readable recording medium storing a bitstream of a video which is generated by a method performed by a video processing apparatus, wherein the method comprises: determining a target motion candidate based on a plurality of motion vectors using a predetermined operation; constructing a motion candidate list for a target block; adding the target motion candidate into the motion candidate list; and generating a bitstream of the target block based on the motion candidate list.
Clause 124. A method for storing bitstream of a video, comprising: determining a target motion candidate based on a plurality of motion vectors using a predetermined operation; constructing a motion candidate list for a target block; adding the target motion candidate into the motion candidate list; generating a bitstream of the target block based on the motion candidate list; and storing the bitstream in a non-transitory computer-readable recording medium.
Clause 125. A non-transitory computer-readable recording medium storing a bitstream of a video which is generated by a method performed by a video processing apparatus, wherein the method comprises: determining, during a conversion between a target block of a video and a bitstream of the target block, a merge candidate list for the target block which is coded with a merge mode with motion vector differences (MMVD) mode; determining a plurality of merge candidates that are allowed for the MMVD mode; and generating a bitstream of the target block based on the plurality of merge candidates.
Clause 126. A method for storing bitstream of a video, comprising: determining, during a conversion between a target block of a video and a bitstream of the target block, a merge candidate list for the target block which is coded with a merge mode with motion vector differences (MMVD) mode; determining a plurality of merge candidates that are allowed for the MMVD mode; generating a bitstream of the target block based on the plurality of merge candidates; and storing the bitstream in a non-transitory computer-readable recording medium.

### Example Device

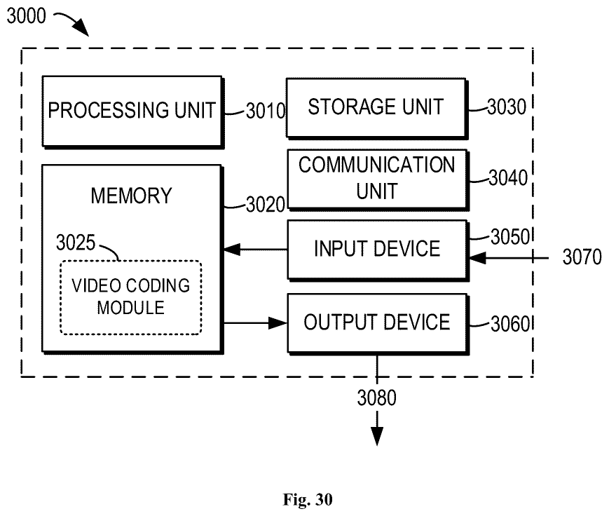

FIG. 30 illustrates a block diagram of a computing device 3000 in which various embodiments of the present disclosure can be implemented. The computing device 3000 may be implemented as or included in the source device 110 (or the video encoder 114 or 200) or the destination device 120 (or the video decoder 124 or 300).

It would be appreciated that the computing device 3000 shown in FIG. 30 is merely for purpose of illustration, without suggesting any limitation to the functions and scopes of the embodiments of the present disclosure in any manner.

As shown in FIG. 30, the computing device 3000 includes a general-purpose computing device 3000. The computing device 3000 may at least comprise one or more processors or processing units 3010, a memory 3020, a storage unit 3030, one or more communication units 3040, one or more input devices 3050, and one or more output devices 3060.

In some embodiments, the computing device 3000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3000 can support any type of interface to a user (such as “wearable” circuitry and the like).

The processing unit 3010 may be a physical or virtual processor and can implement various processes based on programs stored in the memory 3020. In a multi-processor system, multiple processing units execute computer executable instructions in parallel so as to improve the parallel processing capability of the computing device 3000. The processing unit 3010 may also be referred to as a central processing unit (CPU), a microprocessor, a controller or a microcontroller.

The computing device 3000 typically includes various computer storage medium. Such medium can be any medium accessible by the computing device 3000, including, but not limited to, volatile and non-volatile medium, or detachable and non-detachable medium. The memory 3020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3030 may be any detachable or non-detachable medium and may include a machine-readable medium such as a memory, flash memory drive, magnetic disk or another other media, which can be used for storing information and/or data and can be accessed in the computing device 3000.

The computing device 3000 may further include additional detachable/non-detachable, volatile/non-volatile memory medium. Although not shown in FIG. 30, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3040 communicates with a further computing device via the communication medium. In addition, the functions of the components in the computing device 3000 can be implemented by a single computing cluster or multiple computing machines that can communicate via communication connections. Therefore, the computing device 3000 can operate in a networked environment using a logical connection with one or more other servers, networked personal computers (PCs) or further general network nodes.

The input device 3050 may be one or more of a variety of input devices, such as a mouse, keyboard, tracking ball, voice-input device, and the like. The output device 3060 may be one or more of a variety of output devices, such as a display, loudspeaker, printer, and the like. By means of the communication unit 3040, the computing device 3000 can further communicate with one or more external devices (not shown) such as the storage devices and display device, with one or more devices enabling the user to interact with the computing device 3000, or any devices (such as a network card, a modem and the like) enabling the computing device 3000 to communicate with one or more other computing devices, if required. Such communication can be performed via input/output (I/O) interfaces (not shown).

In some embodiments, instead of being integrated in a single device, some or all components of the computing device 3000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3000 may be used to implement video encoding/decoding in embodiments of the present disclosure. The memory 3020 may include one or more video coding modules 3025 having one or more program instructions. These modules are accessible and executable by the processing unit 3010 to perform the functionalities of the various embodiments described herein.

In the example embodiments of performing video encoding, the input device 3050 may receive video data as an input 3070 to be encoded. The video data may be processed, for example, by the video coding module 3025, to generate an encoded bitstream. The encoded bitstream may be provided via the output device 3060 as an output 3080.

In the example embodiments of performing video decoding, the input device 3050 may receive an encoded bitstream as the input 3070. The encoded bitstream may be processed, for example, by the video coding module 3025, to generate decoded video data. The decoded video data may be provided via the output device 3060 as the output 3080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, during a conversion between a target block of a video and a bitstream of the target block, a combined inter and intra prediction (CIIP) mode associated with the target block;
constructing a merge candidate list associated with the CIIP mode;
performing an adaptive merge list reordering to the merge candidate list associated with the CIIP mode; and
performing the conversion based on the reordered merge candidate list.

2. The method of claim 1, wherein the CIIP mode comprises at least one of:
a CIIP with merge mode with motion vector differences (MMVD),
a CIIP with template matching (TM),
a CIIP with affine prediction,
a CIIP with subblock-based temporal motion vector prediction (SbTMVP), or
a multi-hypothesis prediction (MHP).

3. The method of claim 1, wherein the adaptive merge list reordering is not allowed to be applied to a CIIP variant.

4. The method of claim 1, wherein the adaptive merge list reordering is applied to a first CIIP variant, and
wherein the adaptive merge list reordering is not allowed to be applied to a second CIIP variant.

5. The method of claim 4, wherein the second CIIP variant is a CIIP with affine prediction, and the adaptive merge list reordering is not allowed to be applied to the CIIP with affine prediction.

6. The method of claim 1, wherein a CIIP prediction is generated based on coding information.

7. The method of claim 6, wherein the CIIP prediction is an intermediate prediction which constructs a final predication of a CIIP variant.

8. The method of claim 7, wherein the CIIP variant comprises one of:
a CIIP with MMVD,
a CIIP with TM,
a CIIP with affine, or
a CIIP with sbTMVP.

9. The method of claim 1, wherein a weighting value to generate a final prediction for CIIP depends on how intra-prediction and inter-prediction are generated.

10. The method of claim 9, wherein the weighting value depends on at least one of:
how the inter-prediction is generated, or
how the intra-prediction is refined.

11. The method of claim 1, further comprising:
determining a merge candidate list for the target block which is coded with a merge mode with motion vector differences (MMVD) mode;
determining a plurality of merge candidates that are allowed for the MMVD mode; and
performing the conversion comprises performing the conversion based on the plurality of merge candidates.

12. The method of claim 11, wherein the MMVD mode comprises a combined intra and inter prediction (CIIP) with MMVD.

13. The method of claim 11, wherein the number of maximum allowed merge candidates for the target block is equal to the number of maximum allowed general merge candidates.

14. The method of claim 11, wherein a merge index of the target block is equal to a value which is greater than a first predetermined number.

15. The method of claim 11, wherein if the target block is coded with a skip mode, the number of MMVD merge candidates is allowed to be greater than a second predetermined number.

16. The method of claim 11, wherein if the target block is coded with a skip mode, an indicated merge index is allowed to be greater than a third predetermined number.

17. The method of claim 11, wherein if the target block is coded with a skip mode, a merge index is indicated for the target block, and
wherein if the target block is not coded with the skip mode, a merge flag is indicated for the target block.

18. The method of claim 1, wherein the conversion includes encoding the target block into the bitstream, or
wherein the conversion includes decoding the target block from the bitstream.

19. An apparatus for processing video data comprising a processor and a non-transitory memory with instructions thereon, wherein the instructions upon execution by the processor, cause the processor to perform a method comprising:
determining, during a conversion between a target block of a video and a bitstream of the target block, a combined inter and intra prediction (CIIP) mode associated with the target block;
constructing a merge candidate list associated with the CIIP mode;
performing an adaptive merge list reordering to the merge candidate list associated with the CIIP mode; and
performing the conversion based on the reordered merge candidate list.

20. A non-transitory computer-readable storage medium storing instructions that cause a processor to perform a method comprising:
determining, during a conversion between a target block of a video and a bitstream of the target block, a combined inter and intra prediction (CIIP) mode associated with the target block;
constructing a merge candidate list associated with the CIIP mode;
performing an adaptive merge list reordering to the merge candidate list associated with the CIIP mode; and
performing the conversion based on the reordered merge candidate list.
